(19) United States
(12) Patent Application Publication
(10) Pub. No.: US 2009/0192873 A1
(43) Pub. Date: Jul. 30, 2009

(54) APPARATUSES, METHODS AND SYSTEMS FOR A DONATION-COORDINATING ELECTRONIC MARKET PLATFORM

(76) Inventor: John Joseph Marble, Seattle, WA (US)

Correspondence Address: CHADBOURNE & PARKE LLP, 30 ROCKEFELLER PLAZA, NEW YORK, NY, 10112, US

(21) Appl. No.: 12/197,639

(22) Filed: Aug. 25, 2008

Related U.S. Application Data
(60) Provisional application No. 60/957,962, filed on Aug. 24, 2007.
(60) Provisional application No. 60/969,387, filed on Aug. 31, 2007.
(60) Provisional application No. 60/969,400, filed on Aug. 31, 2007.
(60) Provisional application No. 60/969,404, filed on Aug. 31, 2007.
(60) Provisional application No. 60/969,421, filed on Aug. 31, 2007.
(60) Provisional application No. 60/969,433, filed on Aug. 31, 2007.
(60) Provisional application No. 60/969,466, filed on Aug. 31, 2007.
(60) Provisional application No. 60/969,473, filed on Aug. 31, 2007.

(51) Int. Cl. G06Q 40/00; G06Q 20/00; G06F 15/16; G06Q 30/00

(52) U.S. Cl. 705/10; 705/39; 709/204

(57) ABSTRACT

The present disclosure details apparatuses, methods, and systems for a donation-coordinating electronic market platform that coordinates interactions and transactions between platform participants to facilitate the allocation of charitable donations based on consumer purchases. The platform sits at the intersection between charitable giving and retail transacting that is enabled by web-tools, search technology and electronic transaction processing. As such many new relationships are formed by the creation of a new set of technology links and functionality. The platform is configurable to collect, maintain, and update profile information for all participating entities; to link sales, marketing, advertising, and financial settlement; to track and report on consumer purchases, charitable donations, and advertising efficacy; and to build consumer loyalty while fostering a donation momentum that streamlines and maximizes the impact of charitable giving across market sectors.

### PRIORITY CLAIMS AND RELATED APPLICATIONS

This is a Non-Provisional of and claims priority under 35 U.S.C. § 119 to prior U.S. Provisional Patent Application No. 60/957,962 filed Aug. 24, 2007, entitled, “Apparatuses, Methods and Systems for a Donation-Coordinating Electronic Market Platform,” (Attorney Docket No. 188356-002PV); U.S. Provisional Patent Application No. 60/969,387 filed Aug. 31, 2007, entitled, “APPARATUSES, METHODS AND SYSTEMS FOR A DONATION-CENTERED ELECTRONIC SEARCH PLATFORM,” (Attorney Docket No. 18356-002PV1); U.S. Provisional Patent Application No. 60/969,400 filed Aug. 31, 2007, entitled, “APPARATUSES, METHODS AND SYSTEMS FOR A DONATION-DIRECTED PURCHASE VERIFICATION PLATFORM,” (Attorney Docket No. 188356-002PV2); U.S. Provisional Patent Application No. 60/969,404 filed Aug. 31, 2007, entitled, “APPARATUSES, METHODS AND SYSTEMS FOR A DONATION-COORDINATING ELECTRONIC MARKET PLATFORM,” (Attorney Docket No. 18356-002PV3); U.S. Provisional Patent Application No. 60/969,421 filed Aug. 31, 2007, entitled, “APPARATUSES, METHODS AND SYSTEMS FOR A BRAND SELECTION INTERFACE GENERATION PLATFORM,” (Attorney Docket No. 18356-002PV4); U.S. Provisional Patent Application No. 60/969,433 filed Aug. 31, 2007, entitled, “APPARATUSES, METHODS AND SYSTEMS FOR AN ADVERTISEMENT FULFILLMENT TRACKING PLATFORM,” (Attorney Docket No. 18356-002PV5); U.S. Provisional Patent Application No. 60/969,466 filed Aug. 31, 2007, entitled, “APPARATUSES, METHODS AND SYSTEMS FOR A SOCIAL NETWORK MEDIATED TRANSACTION AND DONATION PLATFORM,” (Attorney Docket No. 18356-002PV6); and U.S. Provisional Patent Application No. 60/969,473 filed Aug. 31, 2007, entitled, “APPARATUSES, METHODS AND SYSTEMS FOR A TARGETED CATALOG GENERATION PLATFORM,” (Attorney Docket No. 18356-002PV7).

The entire contents of the aforementioned eight applications are herein expressly incorporated by reference.

### FIELD

The present invention is directed generally to apparatuses, methods, and systems of commerce, and more particularly, to apparatuses, methods and systems for a donation-coordinating electronic market platform.

### BACKGROUND

Cause-related marketing (CRM) and charitable giving programs related to consumer purchases have come about, allowing retailers and brands to attract and compete for customers by offering to donate a portion of the cost of purchased items to one or more charities or causes. Often, products are marked or branded with a distinctive logo or style to indicate their inclusion in these programs, such as pink yogurt container lids for Yoplait's “Save Lids to Save Lives” breast-cancer research support campaign or the (Product)^{Red} brand indicating support for the Global Fund that has been applied to a variety of different consumer products. Some credit card companies provide charity donations for most or all purchases made with select credit cards. The advent and proliferation of online shopping has led to the establishment of charity malls and portals, through which a consumer may purchase products and have a portion of their payment redirected to one or more charities that are selected either by the proprietors of the mall/portal or by the customer.

### SUMMARY

This disclosure details the implementation of apparatuses, methods, and systems for a donation-coordinating electronic market platform (hereafter, “Platform”). Existing CRM schemes and programs provide only limited shopping and donating opportunities. A need exists for a convenient and efficient platform for mediating communications, agreements, transactions, programming, advertising, partnering, administering, accounting, and reporting for and between different CRM and related entities including brands, customers, charities and/or other causes, matching fund agencies, payment brands, online search engine services, and/or the like. The Platform satisfies that need. By facilitating interactions between these various entities, the Platform vastly expands opportunities and means for providing donations to causes and charities based on consumer purchases. The Platform may be configured to collect, maintain, and update profile information for all participating entities; to link sales, marketing, advertising, and financial settlement; to track and report on consumer purchases, cause donations, and advertising efficacy; and to build consumer loyalty while fostering a donation momentum that streamlines and maximizes the impact of charitable giving across market sectors. The Platform sits at the intersection point of charitable giving and retail transacting that is enabled by web-tools, search technology and electronic transaction processing. As such many new relationships are formed by the creation of a new set of technology links and functionality.

In one embodiment, a method for coordinating donations is disclosed, comprising: receiving a brand donation commitment contingent on a triggering consumer purchase from at least one brand; receiving a co-donation commitment contingent on the triggering consumer purchase from at least one consumer associate; receiving a consumer purchase confirmation message, wherein the consumer purchase confirmation message confirms that the triggering consumer purchase has taken place; generating an account of brand fund transfer from the brand to at least one consumer-selected cause based on the brand donation commitment; and generating an account of consumer associate fund transfer from the consumer associate to at least one consumer-selected cause based on the co-donation commitment.

### BRIEF DESCRIPTION OF THE DRAWINGS

The accompanying appendices and/or drawings illustrate various non-limiting, example, inventive aspects in accordance with the present disclosure:

FIGS. 1A-B show data flow between various entities comprising and/or in communicative contact with the Platform in embodiments of Platform operation;

FIGS. 2A-B show implementations of user interfaces for brand registration and registered brand homepages within embodiments of Platform operation;

FIG. 3 shows an implementation of a user interface for cause registration in one embodiment of Platform operation;

FIG. 4 shows an implementation of combined data and logic flow for consumer/donor registration in one embodiment of Platform operation;

FIGS. 5A-D illustrate implementations of user interfaces for initial login and co-donor and/or consumer/donor registration in embodiments of Platform operation;

FIG. 6 shows an implementation of co-donation log in and setup in one embodiment of Platform operation;

FIG. 7 shows an implementation of combined data and logic flow for offer generation and acceptance in one embodiment of Platform operation;

FIG. 8 shows an implementation of combined data and logic flow for offer-donation receipt and/or inquiry in another embodiment of Platform operation;

FIG. 9 shows an implementation of combined data and logic flow for offer-donation creation in another embodiment of Platform operation;

FIG. 10 shows an implementation of a user interface for generating and/or activating an offer-donation in one embodiment of Platform operation;

FIG. 11 shows an implementation of an offer-donation manifested as an email message in one embodiment of Platform operation;

FIG. 12 shows an implementation of logic flow for offer generation and acceptance within an alternative embodiment of Platform operation;

FIG. 13 shows an implementation of offer fulfillment in one embodiment of Platform operation;

FIGS. 14A-B show implementations of offer fulfillment in alternative embodiments of Platform operation;

FIGS. 15A-C show customer purchase receipts for on-network purchases indicating Platform-coordinated donation amounts in some embodiments of Platform operation;

FIG. 16 shows an accounting breakdown of the funds and donations underlying the receipt shown in FIG. 15C;

FIGS. 17A-C show customer purchase receipts for on-network purchases indicating Platform coordinated donation amounts in alternative embodiments of Platform operation;

FIG. 18 shows an implementation of matching fund acquisition in an alternative embodiment of Platform operation;

FIG. 19 shows an implementation of donation flow and facilitation in one embodiment of Platform operation;

FIG. 20 shows an implementation of search functionality in one embodiment of Platform operation;

FIG. 21 shows an implementation of pay-per-action advertising in one embodiment of Platform operation;

FIG. 22 shows an implementation of logic flow for voluntary and/or direct donation processing in one embodiment of Platform operation;

FIGS. 23A-G showcase illustrations of alternative implementations of user interfaces for particular aspects of Platform functionality within alternative embodiments of Platform operation; and

FIG. 24 is of a block diagram illustrating embodiments of the present invention of a Platform controller.

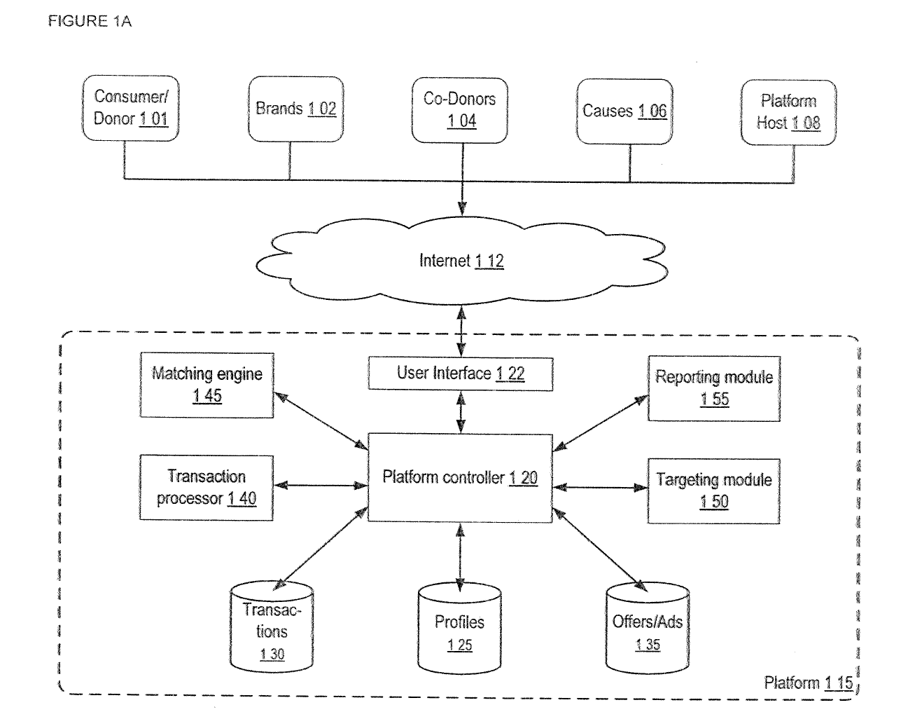

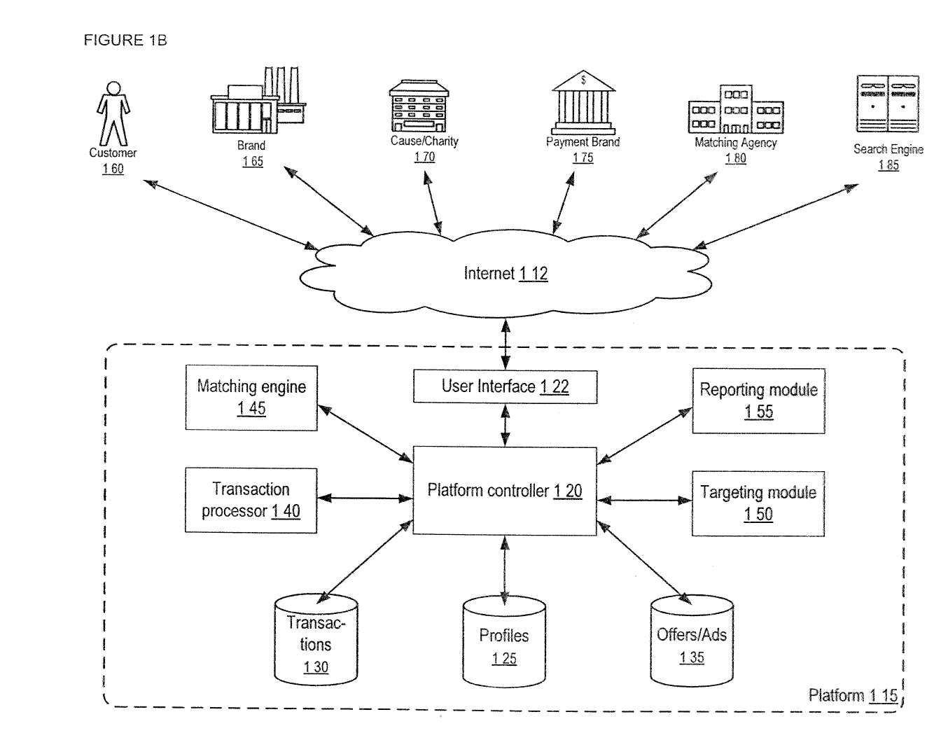

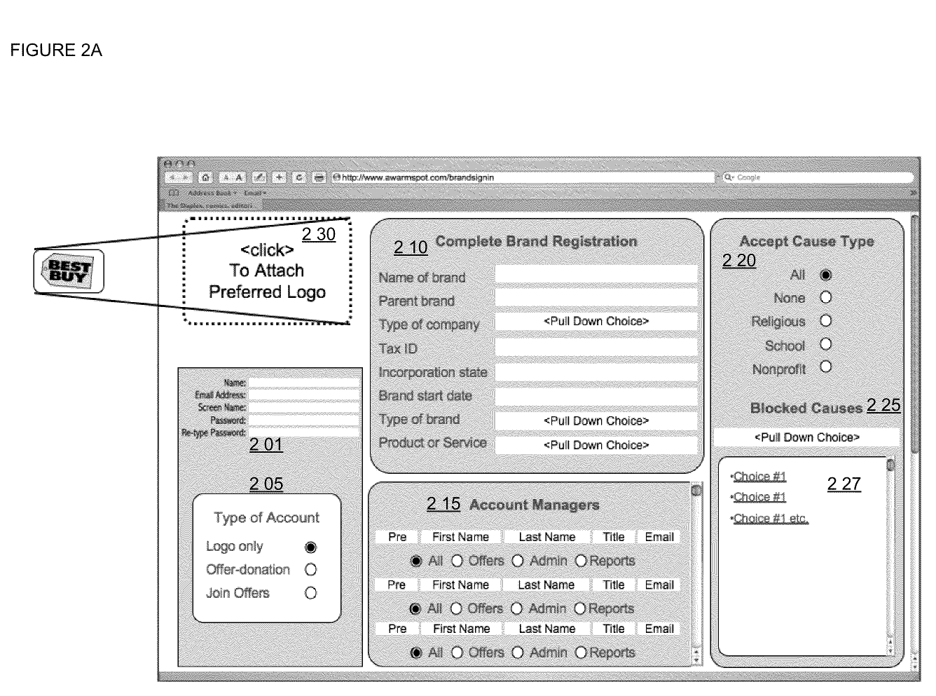

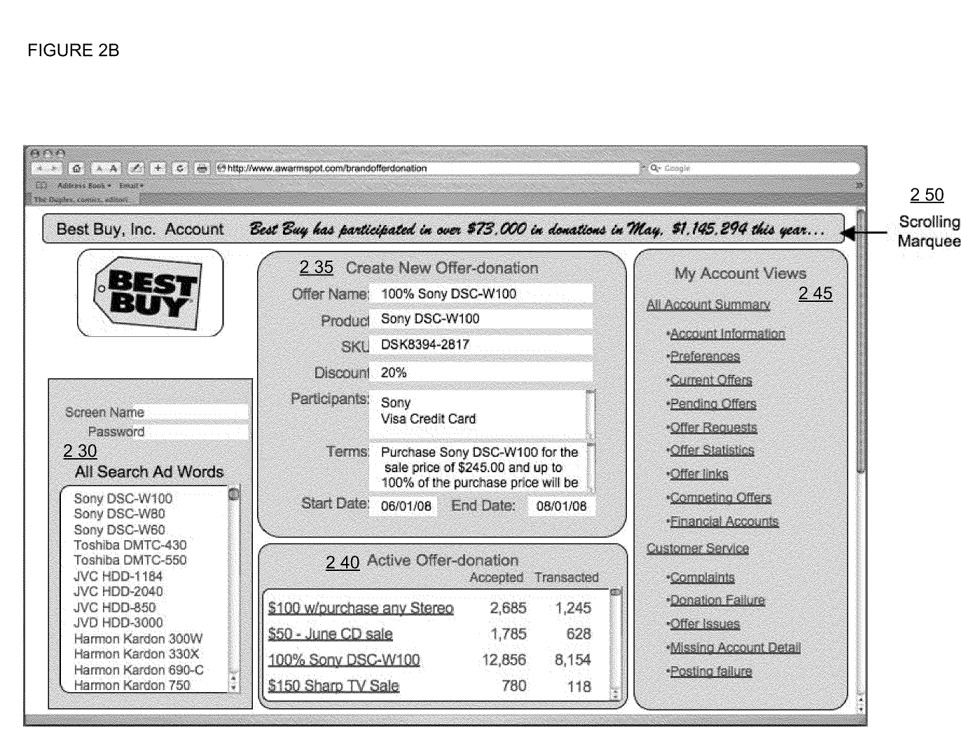

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

This disclosure describes inventive aspects of at least seven distinct inventions:
a donation-centered electronic search platform (with a suggested Class/Subclass of 705/27);

a donation-directed purchase verification platform (with a suggested Class/Subclass of 705/77);
a donation-coordinating electronic market platform (with a suggested Class/Subclass of 705/39);
a brand selection interface generation platform (with a suggested Class/Subclass of 715/810);
an advertisement fulfillment tracking platform (with a suggested Class/Subclass of 705/26);
a social network mediated transaction and donation platform (with a suggested Class/Subclass of 705/264); and
a targeted catalog generation platform (with a suggested Class/Subclass of 705/27).

The instant application details claims directed to a donation-coordinating electronic market platform (suggested class/subclass: 705/39). However, in order to develop a reader's understanding of the invention(s), the descriptions of the other invention(s) have been compiled into a single disclosure to illustrate and clarify how aspects of these inventions operate independently, interoperate as between individual inventions, and/or cooperate collectively. The disclosure goes on to further describe the interrelations and synergies as between any of the various inventions within the context of an overarching inventive system; all of which is to further ensure compliance with 35 U.S.C. §112.

In order to address various issues such as those discussed above, the invention is directed to systems, methods and apparatuses for a donation-coordinating electronic market platform. It is to be understood that depending on the particular needs and/or characteristics of participating consumers, retail brands, manufacturer brands, causes, charities, payment brands, matching fund agencies, search engine services, and/or the like, various embodiments of the Platform may be implemented that enable a great deal of flexibility and customization. The instant disclosure discusses an embodiment of the Platform in the context of coordinating market participants to allocate funds to causes and charities based on consumer purchases. However, it is to be understood that the system described herein may be readily configured and/or customized for a wide range of applications or implementations. For example, aspects of the Platform system may be adapted for use in allocating funds to other ends, such as gift purchases, debt payments, personal savings, and/or the like, or may be based on other types of purchases or transactions. It is to be understood that the Platform may be further adapted to a variety of other market coordination and fund allocation applications.

### Platform Overview

The Platform provides features and functionalities that maximize the efficacy of charitable donation efforts of an array of participating entities while simultaneously promoting loyalty relationships between consumers and businesses. The Platform sits at the intersection point between charitable giving and retail transacting that is facilitated by web and/or internet tools, search technology, electronic transaction processing, and/or the like. By leveraging these and other functional elements within the Platform system, charitable donations from a variety of otherwise disparate sources may be drawn together and focused to create new levels of giving and cause promotion. At the same time, by allowing consumers to select their own personal beneficiary causes and tying donations to purchase behavior, the Platform is able to promote and solidify brand loyalty in new and unprecedented ways. As a result, brands may be motivated to divert existing funds allocated for marketing, advertising, customer retention, loyalty promotion, corporate philanthropy, public relations, and/or the like to Platform-mediated programs and offers, thus simultaneously achieving their consumer acquisition/retention goals and promoting causes and charities with minimal liability.

A variety of entities may participate, coordinate, interact, and transact within the Platform and/or by means of Platform functionalities. A non-limiting list of such participants, including entity descriptions within particular embodiments, comprises:
Consumer/donor: A person who is both a consumer of products and services as well as focused on contributing (e.g., money, their time, and/or the like) to their own or someone else's cause or fund. The consumer/donor may serve a central role among Platform participants, in that a relationship to the consumer/donor may be the target of all other Platform participants, and much of the transactional activity managed by the Platform is centered on consumer/donor purchase behavior. In interacting with the Platform, a consumer/donor may engender “giving partner” relationships with brands and/or other Platform participants, whereby the consumer/donor's actions stimulate participants to donate to a cause or fund and, in return, the consumer/donor trades brand loyalty and/or other relationships. The consumer/donor may also directly give to causes by a variety of methods, including but not limited to direct money donations, forgoing sales prices on purchased goods and/or services, voluntarily self-taxing any transaction mediated by the Platform, and/or the like. Some examples of possible participating consumer/donors may include individual cause members, new individual givers, matching funds donors, employees, friends and/or family of cause members, and/or the like.
Brand: Any named entity that manufactures and/or sells products and/or services to consumers. In one implementation, brands may comprise the largest new fundraising opportunity for causes, with new funds provided via offer-donations. The source of funds provided via offer-donations may, in one implementation, result from internal redistribution of revenues controlled by the brands that can be retargeted to benefit consumer/donors' causes of choice. In interacting with the Platform, a brand may participate in “giving partner” relationships with consumer/donors, whereby the brand donates to a consumer/donor's cause of choice responsive to consumer/donor purchases and/or loyalty commitments. Brands may create offer-donations through the Platform to mediate these relationships. Some examples of possible participating brands may include retail brands, manufacturing brands, payment facilitation brands (e.g., credit card companies, banks, PayPal, Google Checkout, and/or the like; hereafter, “payment brands”), and/or the like.
Co-donors: Indirectly involved brands, corporations, employers, foundations, and/or the like as well as friends, family members, and/or other associates of consumer/donors that provide additional donations to the consumer/donor's cause of choice as part of a brand's financial transaction with the consumer/donor. In interacting with the Platform, co-donors may engender and/or support personal relationship values with the consumer/donor, and for that may be willing to support the consumer/donor's cause of choice. For example, a bank may be desirous of a consumer/donor's banking relationship; a corporation may seek brand awareness and/or loyalty; an employer may seek a favorable impression from its employees; friends and family may desire to assist the goals of the consumer/donor; foundations may seek a means of reduced-risk giving with consumer/donors as their partners in giving; and/or the like. Some examples of possible participating co-donors may include corporations, brands, employers, friends and family, consumer/donors, foundations, and/or the like.
Cause: A person or group (e.g., charity, non-profit, and/or the like) that is dedicated to a person, project, purpose of concern, and/or the like. In interacting with the Platform, the cause may raise funds at reduced cost, organize and coordinate supportive brands and consumers, manage fund distributions, and/or the like. Some examples of possible participating causes may include charities, non-profits, 501(c)(3) groups associated with for-profit corporations, other for-profit corporation affiliated foundations, independent foundations, and/or the like.
Online search company/Platform host: An online service that provides search and/or other electronic information capabilities to its base of users, which may include consumers, brands, causes, corporations, employers, foundations, and/or the like. The online search company and/or Platform host may implement particular Platform functionalities via native services such as search, account set-up and management, marketing and advertising capabilities, transaction and financial settlement services, website and content management and control, and/or the like.

These and other entities may collaborate with like-minded participants within social groups and/or social networks provided by the Platform that are centered on common causes and/or charitable giving goals. Once enrolled, Platform participants may engage in a unique offer process. In one embodiment, an offer-donation is a retail offer made by a group of brands (e.g., manufacturer, retailer, payment, and/or the like) that provides a significant donation to a consumer/donor's cause of choice in exchange for the consumer/donor accepting the offer-donation and thereby purchasing the goods and/or services offered.

In one implementation, one or more participating entities may generate an offer proposal, and subsequently seek partnerships with other participating entities within the context of offer fulfillment and/or redemption. An offer may comprise any proposal, agreement, contract, inter-party arrangement, and/or the like configured to associate a donation commitment with the purchase or receipt of goods or services. Examples of some possible offer terms are:
Make a $100 donation to the charity of your choice and receive a free gallon of milk from participating grocers every week for a year.
Make a $20 donation to your favorite non-profit cause and receive a virtual coupon worth a 20% discount, any or all of which may be further directed towards the total donation amount, on all purchases at participating stores for a specified period of time.
Make a donation to the charity of your choice in any amount greater than $20 and receive a free new product or service.
Make an annualized commitment to purchase a significant amount of goods or services and receive a progressively increasing discount at pre-specified plateau levels, with a minimum of 50% of the savings going to your non-profit cause of choice.
Purchase any of a specified set of vegetarian-friendly products from participating retail locations and have 10% of your purchase amount donated to your favorite animal-rights charity.

In one implementation, an offer comprises a pre-purchase commitment, whereby a customer commits to purchase a product and/or make a charitable donation in exchange for the provision of a benefit by an offer counterparty (e.g., a brand). For example, an offer may commit the accepting customer to purchase a minimum quantity of goods and/or services in exchange for having a sum of money donated to the causes and/or charities of his or her choice. In one implementation, an offer may also compel the accepting customer to commit to a particular purchase method in order to successfully fulfill the offer terms. For example, the offer described above may also require that the customer make the agreed purchases using a credit card, and that the brand, number, and expiration date of the credit card be specified to facilitate identification at the point-of-sale (POS).

In some embodiments, the Platform entities generating an offer may be allowed to specify particular causes, charities, or categories thereof for which donations associated with the offer may or may not be allocated. For example, an offer associated with the purchase of meat products may specify that no donations will be made to the People for the Ethical Treatment of Animals (PETA) by means of that particular offer. Customers accepting an offer with exempted causes and/or charities listed in their profiles may receive a warning message indicating the donation restrictions associated with the offer.

An offer may further comprise additional information, such as descriptive keywords, tags, or phrases based on which Platform users may search or be matched to the offers. Offer generation may proceed in a variety of different manners within different embodiments and implementations of Platform operation. In one implementation, an offer may be generated by filling out an online form, such as may be provided on a Platform website. In such an implementation, offer originators may select offer terms from a list of pre-approved offer terms and simply enter the product identification information for the products or services to which the offer terms are to apply. The Platform may employ a set of offer templates for commonly used offer types, which may be provided to potential offer originators to assist with the generation of new offers. The originators may also be provided with a form to allow the generation of free-form offers not embodied in existing offer templates. Such free-form offers may be subject to approval by Platform administrators and/or compared to a set of offer approval criteria. In another implementation, an offer may be generated separately, such as via a client-side Platform application or simply as a text file that is submitted for processing to the Platform.

In one embodiments any Platform participant may make a donation offer to any other participant, and these offers may be formally established, acted upon, and transacted within the context of Platform services. A participant may choose to make available his or her personal money, airline miles, hotel points, retail credits, products, services, and/or the like to another participant within the context of an offer-donation. Many such offer-donations may originate with brand participants, who may develop the offer-donations directly, in association with other brands, or by means of third parties (e.g., an advertising agency) on behalf of the brands.

In one implementation of offer-donations, the Platform may establish value limits on offer-donations, setting boundaries on the definition of an acceptable offer-donation. For example, the Platform may define a minimum value limit, such as a minimum dollar amount and/or percentage of a purchase price, that must go to a consumer/donor's cause of choice within an offer-donation.

In some implementations, the Platform may provide tools to allow causes to block certain offer-donations deemed inappropriate or offensive in light of the cause's stated goals and/or to reach out to brands and/or offer-donations it deems particularly suitable for its goals. An example of this latter situation might be the relationship between Habitat for Humanity and a national hardware store. An offer-donation may be configured to promote the purchase of new tools that could subsequently be gifted to the cause itself. Habitat for Humanity may even communicate with Platform participants via Platform tools and/or functionalities to encourage them to use their purchased tools in a volunteer capacity prior to donating them.

In some implementations, an offer-donation's value may vary depending on where and how it is publicized. The more that a particular publication channel can recognize and/or target particular consumer/donors and understand their particular relationships with the brands participating in the offer-donations, the more the brands can tailor the value proposition of the offer-donation to reflect that understanding. For example, direct email publication or publication in response to an online search via Platform modules allows for the Platform to identify the consumer/donor and consider his or her loyalty relationship to the brand in selecting a donation amount. Furthermore, the Platform may query the consumer/donor's profile to determine what, if any, co-donations from other Platform participants may also be factored into the value proposition, and these may be incorporated into the offer-donation publication.

In one implementation, co-donations are funds that come from relationships that are outside the specific offer-donation, but that are in support of the consumer/donor and their cause of choice. Such co-donations may be contingent upon a consumer/donor transaction within the context of a particular type of offer-donation, or they may apply to consumer transactions within any offer-donations. In some implementations, restrictions may be imposed on the co-donation amounts as a total amount and/or as a percentage of the purchase price for products and/or services within the context of an offer-donation. In another implementation, the combined donation amount of the offer-donation itself and co-donations may be restricted and/or subject to limitations.

### Platform Data Flow

FIG. 1A shows data flow between various entities comprising and/or in communicative contact with the Platform in one embodiment of Platform operation. A variety of participants may employ and/or interact with the Platform and/or Platform functionality, including consumer/donors 101, brands 102, co-donors 104, Causes 106, and a Platform host 108. In FIG. 1A, these various entities are shown in communicative contact, via the internet 112 or other communications network(s), with the Platform 115 via a Platform controller 120. The Platform controller 120 may be configured to serve a central role in Platform operation, communicatively coupled to various external entities, user interfaces, and internal Platform modules and databases to direct data and instructions there between.

The Platform controller 120 may be coupled to a user interface 122, which may serve as a conduit by which external entities and users may view, inspect, interact with, modify, and manipulate Platform modules, data, processes, and/or the like. Through user interface functionalities, users may submit personal profile information; generate, browse, and/or accept offers; make purchases; display advertisements; provide donations; access search engine functionality and/or search the internet; monitor, view, and/or track purchases, donations, advertisement efficacy, Platform activity, and/or the like; generate and view reports; communicate with other participating entities, such as via real-time voice or text chat, voice or text messaging, web logs, and/or the like; and/or the like. In one embodiment, the user interface 122 may comprise a client-side application. A discussion of some exemplary user interface functionalities is provided below.

The Platform controller 120 may further be coupled to a profiles database 125, which may store profiles and/or various data pertaining to any or all entities participating in and/or interacting with the Platform system. Profiles stored within the profiles database 125 may, for example, contain information pertaining to participant identification, characteristics, preferences, associations, Platform activities, and/or the like.

The Platform controller 120 may further be coupled to a transactions database 130, which may store various data pertaining to any or all Platform mediated transactions between participating entities. Records stored within the transactions database 130 may, for example, contain information pertaining to transaction participants, payment and/or donation amounts, payment methods, locations, products, associated advertisements and/or offers, and/or the like. In one implementation, transaction information is associated with and/or stored within participant profiles and/or a profile database 125.

The Platform controller 120 may further be coupled to an offers and/or ads database 135, which may store various data pertaining to any or all offers and/or ads generated by participating entities. Records stored within the offers and/or ads database 135 may, for example, contain information pertaining to offer originators, offer participants, offer acceptances, offer fulfillments, offer terms, offer timeframes, offer descriptors and/or keywords, ad originators, ad impressions, ad clicks, ad consummations, ad contents, ad descriptors and/or keywords, and/or the like. In one embodiment, separate databases are employed for storing records pertaining respectively to offers and ads.

The Platform controller 120 may further be coupled to a transaction processor module 140, which may receive, process, and distribute data pertaining to any or all Platform mediated transactions between participating entities. The transaction processor module may be configured, for example, to monitor offers, receive acceptance notifications, process offer fulfillment confirmation requests, determine price adjustments and/or donation amounts, allocate and/or aggregate funds, mediate payments and/or donations, generate notifications, determining and/or soliciting advertising fees, and/or the like.

The Platform controller 120 may further be coupled to a matching engine module 145, which may process and/or distribute various data pertaining to the participation of entities in advertising, offers, and donation commitments. The matching engine module may be configured, for example, to connect and/or coordinate Platform participants, target offers and/or ads to participants, track donation commitments, manage offer/ad/participant tags, and/or the like.

The Platform controller 120 may further be coupled to a sorting module 150, which may process listings of offers, Platform participants, product listings, and/or the like. The sorting module may be configured, for example, to process expected donation amounts, assign scores and/or priorities to listing elements, set display attributes, and/or the like.

The Platform controller 120 may further be coupled to a reporting module 155, which may process, distribute, and/or display various data pertaining to Platform participant activities. The reporting module may be configured, for example, to collect and/or track Platform participant activity information; generate reports, charts, tables, graphs, lists, and/or the like pertaining to Platform participant donation activity; generate receipts and/or generate information for inclusion in receipts; and/or the like. Among the information that may be included in Platform generated reports within embodiments of Platform operation are total donations; time resolved donations and/or donations made within a specified time period; cause and/or charity resolved donations and/or donations made within a particular sector of causes and/or charities (e.g., education, religious, non-profit, political, etc.); personal and/or voluntary donations; donations made by other Platform entities based on personal purchases; matching fund amounts; donations per dollar spent on product and/or service purchases; tax deductible donations and/or tax deduction amounts; pay-per-action and/or other advertising expenditures; offers generated, accepted, fulfilled, and/or the like; and/or the like.

FIG. 1B shows data flow between various entities comprising and/or in communicative contact with the Platform in an alternative embodiment of Platform operation. A customer 160, brand 165, cause and/or charity organization 170, payment brand 175, matching fund agency 185, search engine 190, and/or any other participating entity may communicate via the internet 112 or other communications network with the Platform 115 via a Platform controller 120. In various embodiments, customers may comprise individual consumers, groups, organizations, institutions, businesses, and/or any other entities capable of purchasing goods and/or services; brands and/or merchants may comprise stores, businesses, factories, brand owners, distributors, and/or any other entities capable of producing, providing, advertising, distributing, and/or selling goods and/or services; causes and/or charity organizations may comprise non-profit organizations, churches or religious groups, schools, clubs, activities, advocacy groups, funds, and/or any other entity that solicits and/or accepts donations; payment brands may comprise credit card companies, banks, and/or any other entities providing credit, loan, or payment facilitation capabilities; matching fund agencies may comprise groups, businesses, non-profit organizations, foundations, endowments, and/or any other entities providing matching funds for donations; and search engines may comprise any groups, businesses, websites, and/or the like that provide internet searching capabilities.

Within various embodiments and/or implementations, any or all of the aforementioned Platform components, modules, and databases may be reconfigured as components of the Platform controller 120 itself. Further aspects and embodiments of Platform, Platform controller, and Platform component operation are described below.

### Band Registration

FIGS. 2A-B show implementations of user interfaces for brand registration and registered brand homepages within embodiments of Platform operation. A brand wishing to participate in generating offer-donations, communicating with Platform participants, and/or any other Platform functionalities may first interact with a brand registration interface such as that shown in FIG. 2A in order to provide information about itself. These include a collection of fields 201 wherein the brand can enter a name, contact email address, screen name, and password. Below those fields is a window 205 for specifying the type of account that the brand wishes to engender. Some possible account types are shown: a “logo only” account, whereby the brand neither creates nor joins offer-donations, but may otherwise participate in and/or employ Platform functionalities; an “offer-donation” account, whereby the brand may create and join offer-donations; and, a “join offers” account, whereby the brand may join but not create offer-donations.

At 210 is a window to enter additional brand-related information, including a brand name, a parent brand, a company type, a tax identification (ID), a state in which the brand is incorporated, a brand start date, a brand type, and products and/or services with which the brand is involved. In the displayed implementation, the “type of company”, “type of brand”, and “product or service” fields are implemented as pull-down menus, wherefrom a brand may select an option from a collection of pre-set possibilities.

A window is provided at 215, wherein a brand may enter information pertaining to managers designated for the brand's Platform account. Each line admits manager information, including a prefix, a first name, a last name, a job title, and an email address. In addition, there are radio buttons configured to receive information pertaining to the account manager's permissions. In the displayed implementation, these buttons admit four values: an “all” button, granting all of permissions and/or access afforded to the other permission levels; an “offers” button granting permission to generate and/or otherwise manage new offer-donations and generate reports; an “admin” button granting permission to manage existing offer-donations and generate reports; and a “reports” button granting permission to generate reports.

A window provided at 220 allows a brand to specify acceptable cause types. In the displayed implementation, the window includes a radio button menu of cause types including religious, school, nonprofit, all, and none. It should be appreciated that many other cause types and/or categories may be included in such a menu in alternative implementations. Selection of one or more cause types may direct brand offers favorably towards social networks and/or consumer/donors and/or other Platform participants associated with causes matching those types. The window also includes a pull-down menu admitting inputs pertaining to blocked causes and/or cause types 225. This allows a brand to specify causes and/or cause types for which its offers, products, and/or the like should not be used. For example, a meat processing brand may elect to block an animal rights cause and its members from receiving its offers, as they may be expected to pose a conflict of interest. A listing of the brand's blocked causes is provided at 227.

Finally, the displayed implementation includes an interface component 230 allowing the brand to upload an image comprising a logo, trademark, symbol, and/or the like. The uploaded image may be employed to represent the brand in other aspects of Platform functionality, some of which are described below.

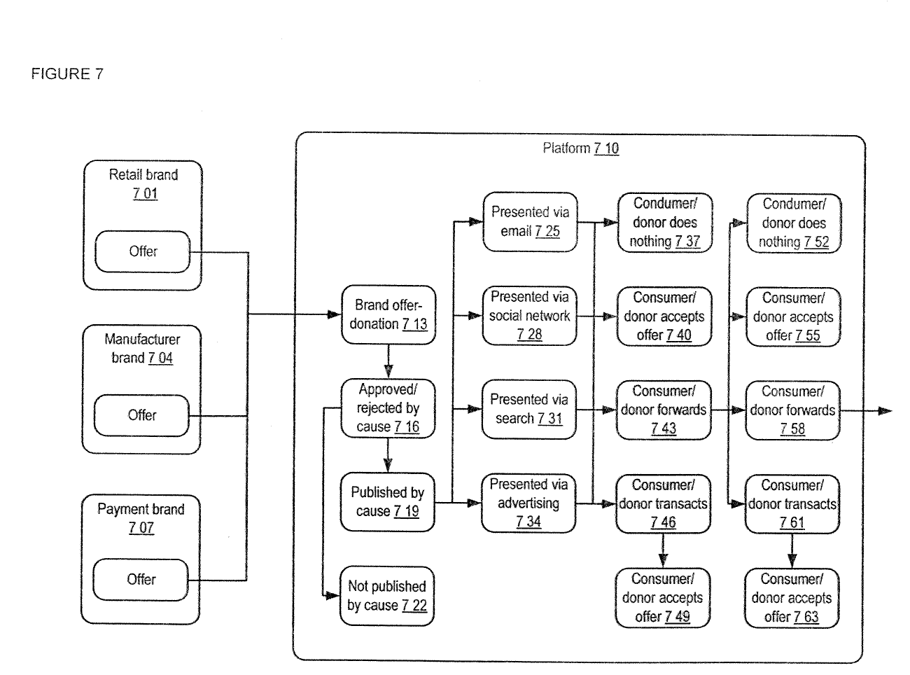

FIG. 2B shows an implementation of a Platform homepage displayed to a brand subsequent to successful registration. The page may include a window listing all search words and/or strings that may lead to offer-donations originated by the brand and/or with which the brand has entered a partnership. There is also a window 235 for initiating the creation of a new offer-donation which includes a variety of fields specifying characteristics of the offer-donation, such as an offer name, an associated product, a stock keeping unit (SKU) number corresponding to the product, a discount amount, partnering participants, offer-donations terms, a start date and end date; and/or the like. Further details surrounding offer-donation creation are provided below with reference to FIGS. 7-12. Previously created and/or pending offer-donations associated with the brand are listed in a separate window 240. On the right, a window 245 is provided with a collection of links allowing for the creation of account view, reports, and/or the like, including an all account summary, account information, preferences, current offers, pending offers, offer requests, offer statistics, offer links, competing offers, financial accounts, and/or the like. The window may further include links such as general customer service, complaints, donation failure assistance, offer issues assistance, missing account detail assistance, posting failure assistance, and/or the like. Finally, the displayed implementation includes a scrolling marquee 250 showcasing the brand's donation record.

### Cause Registration

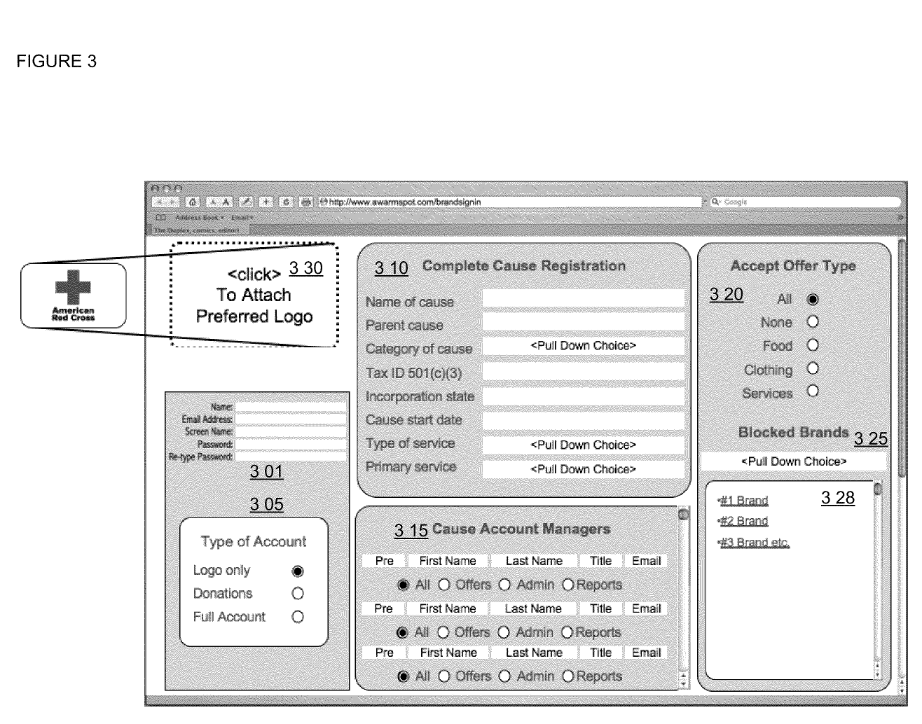

FIG. 3 shows an implementation of a user interface for cause registration in one embodiment of Platform operation. A cause wishing to participate in receiving donations via offer-donations, communicating with Platform participants, and/or any other Platform functionalities may first interact with a cause registration interface such as that shown in FIG. 3 in order to provide information about itself. These include a collection of fields 301 wherein the cause can enter a name, contact email address, screen name, and password. Below those fields is a window 305 for specifying the type of account that the cause wishes to engender. Some possible account types are shown: a “logo only” account, whereby the cause appears in name/logo only, but may participate in and/or employ Platform functionalities to a limited degree; a “donations” account, whereby the cause may receive donations from Platform participants; and, a “full account” account, whereby the cause may receive donations and take full advantage of other Platform functionality available to causes.

At 310 is a window to enter additional cause-related information, including a cause name, a cause parent, a category of cause, a tax ID (e.g., 501(c)(3) status), a state in which the cause is incorporated, a cause start date, a service type for services rendered by the cause, and a primary service with which the cause is involved. In the displayed implementation, the “category of cause”, “type of service”, and “primary service” fields are implemented as pull-down menus, wherefrom a cause may select an option from a collection of pre-set possibilities.

A window is provided at 315, wherein a cause may enter information pertaining to managers designated for the cause's Platform account. Each line admits manager information, including a prefix, a first name, a last name, a job title, and an email address. In addition, there are radio buttons configured to receive information pertaining to the account manager's permissions. In the displayed implementation, these buttons admit four values: an “all” button, granting all of permissions and/or access afforded to the other permission levels; an “offers” button granting permission to accept and manage offer-donation funds and generate reports; an “admin” button granting permission to manage offer-donation funds and generate reports; and a “reports” button granting permission to generate reports.

A window provided at 320 allows a cause to specify acceptable offer-donation and/or brand types. In the displayed implementation, the window includes a radio button menu of offer types including food, clothing, services, all, and none. It should be appreciated that many other types of brands, offers, and/or the like may be included in such a menu in alternative implementations. Selection of one or more offer types may direct brand offers matching those types favorably towards the cause, cause members, associated social networks, and/or the like. The window also includes a pull-down menu admitting inputs pertaining to blocked brands and/or brand types 325. This allows a cause to specify brands and/or brand types for which its offers, products, and/or the like should not be used. Using a similar example to that used for brand registration, an animal rights cause may wish to block offer-donations from a meat processing brand, owing to the resulting conflict of interest. There is also a window at 328 wherein a cause has listed its favorite brands, whose offer-donations may be preferentially supplied to the cause.

Finally, the displayed implementation includes an interface component 330 allowing the cause to upload an image comprising a logo, trademark, symbol, and/or the like. The uploaded image may be employed to represent the cause in other aspects of Platform functionality, some of which are described below.

In one embodiment, causes may generate multiple registrations corresponding to varying degrees of cause specificity. For example, the Bill and Melinda Gates Foundation, the foundation's Global Health Division, the Emergency Relief initiative within that division, and a specific fund directed to flood relief within that initiative may all have separate registrations, accounts, pages, and/or the like within the Platform. This allows consumer/donors to select the causes that they wish to support with a wider degree of specificity or generality as their personal beliefs or inclinations dictate.

### Consumer/Donor Registration

In some embodiments, the Platform admits a social network whereby consumer/donors may interact with causes, brands, payment brands, other consumer/donors, and/or any other Platform participants to employ Platform functionalities. In one implementation, brands, causes, corporations, employers, foundations, and/or the like may first be solicited to register with the Platform in order to establish a degree of value within the social network that is attractive for prospective consumer/donors. Once these entities are enrolled, consumer/donors may be solicited (e.g., via causes with which they are already affiliated) to register and/or otherwise enroll with the Platform.

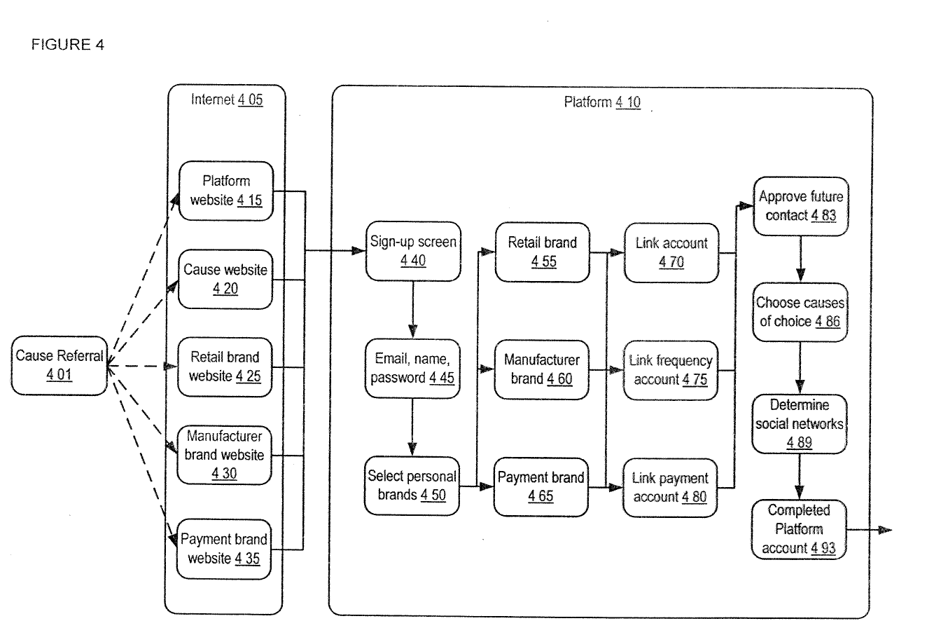

FIG. 4 shows an implementation of combined data and logic flow for consumer/donor registration in one embodiment of Platform operation. In the implementation shown, a cause member is referred at 401 to any Platform 410 participating website and/or other affiliated outlet or enrollment means on the internet 405 by a cause to which that member belongs. In alternative implementations, the consumer/donor may directly go to the participating websites, or may be referred thereto by any other entity or agency. In still another implementation, the prospective consumer/donor may be invited to register by filling out a paper form, such as at a retailer location, point-of-sale, and/or the like, and that information may subsequently be entered into a Platform registration site by a third party. Some possible Platform participating websites may include a Platform website itself 415, a cause website 420, a retail brand website 425, a manufacturer brand website 430, a payment brand website 435, a Platform host and/or search engine website, and/or the like. Platform participating websites may include a link directing prospective consumer/donors to the Platform website itself for further registration activities.

At 440, prospective consumer/donors are supplied with an interface admitting a limited amount of basic sign-up information, such as name, screen name, password, email, and/or the like, which the user enters at 445. The user is then prompted to enter a selection of personal brands 450. In one implementation, the user may be presented with a listing of participating retail brands 455, manufacturer brands 460, payment brands 465, and/or the like which may be organized by types and/or categories, and allowed to select from the brands listed. In one implementation, the image, logo, trademark, symbol, and/or the like uploaded by the brands during their respective registration processes may be employed in the listing if available in lieu of a mere text line of the brand name. As a consumer/donor selects a brand, he or she may be prompted to provide further information pertaining to their brand relationship, such as account ID 470 (e.g., a number on a brand loyalty card), frequency account 475, or payment account 480 (e.g., credit card number) information. In alternative implementations, a consumer/donor may be prompted to enter any information by which the brand can uniquely identify him or her and that may be used in subsequent purchasing to establish a personal loyalty relationship to the brand.

Once brands are selected, the prospective consumer/donor is prompted to approve future contact by the brands and/or the Platform in relation to the brands 483. The prospective consumer/donor then proceeds to select their causes of choice 486, such as from a list of all causes participating in the Platform, and also the social networks to which they want to belong 489. In one implementation, the Platform may select, suggest, and/or automatically enroll the new consumer/donor in social networks which it deems possibly suitable based on the consumer/donor's selection of brands and causes. Based on the information provided, the Platform may determine the appropriate data links between the consumer/donor's profile and those of other Platform participants and may persist these links within those profiles for future reference.

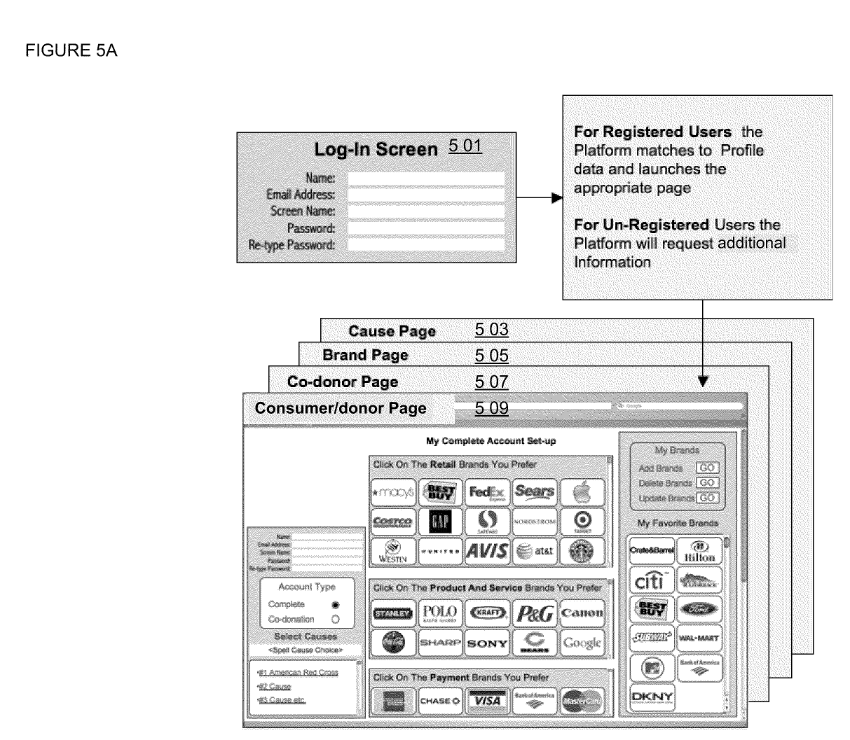

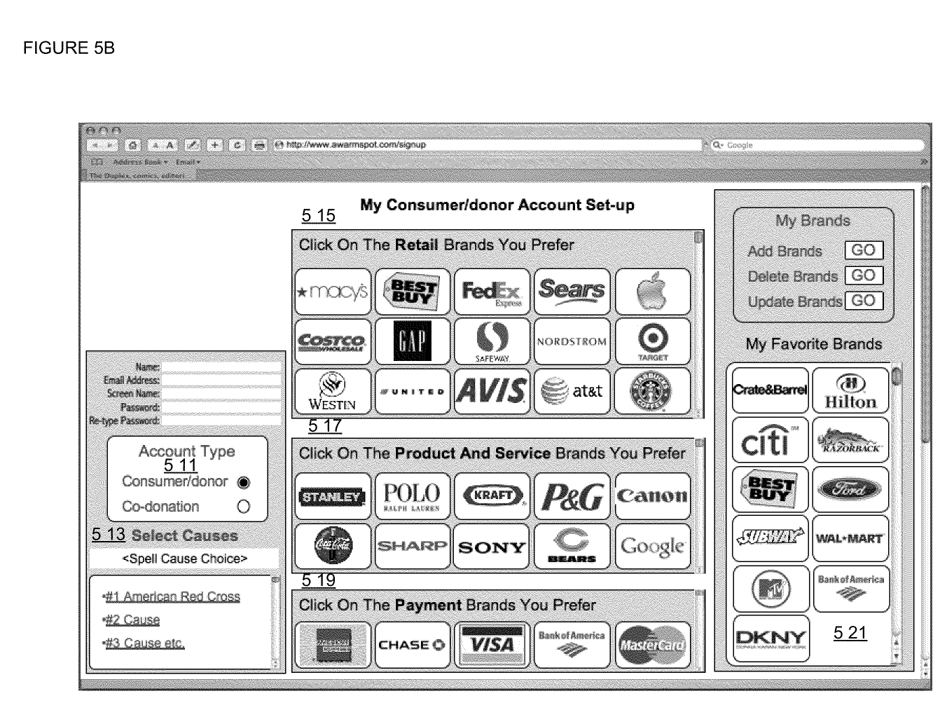

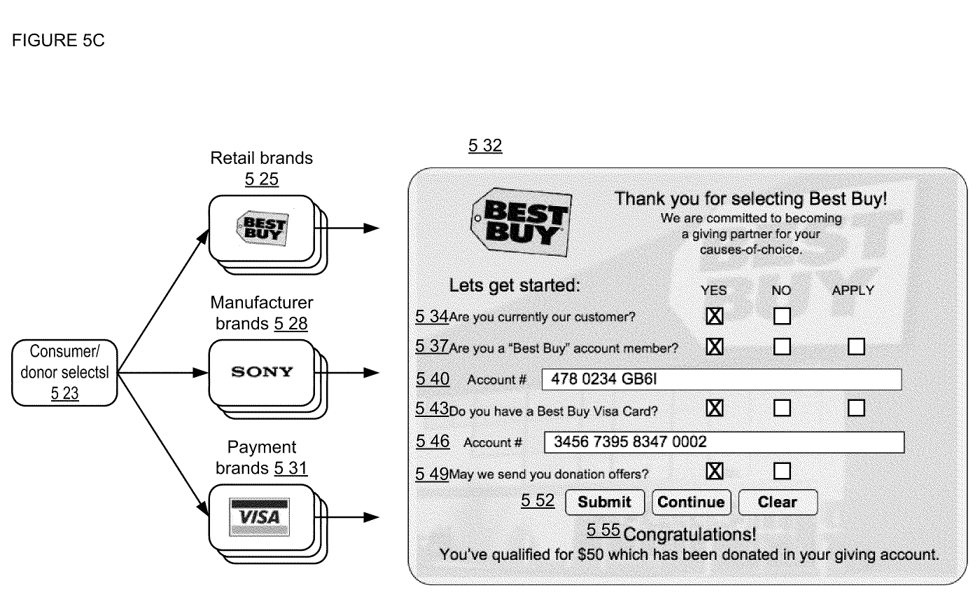

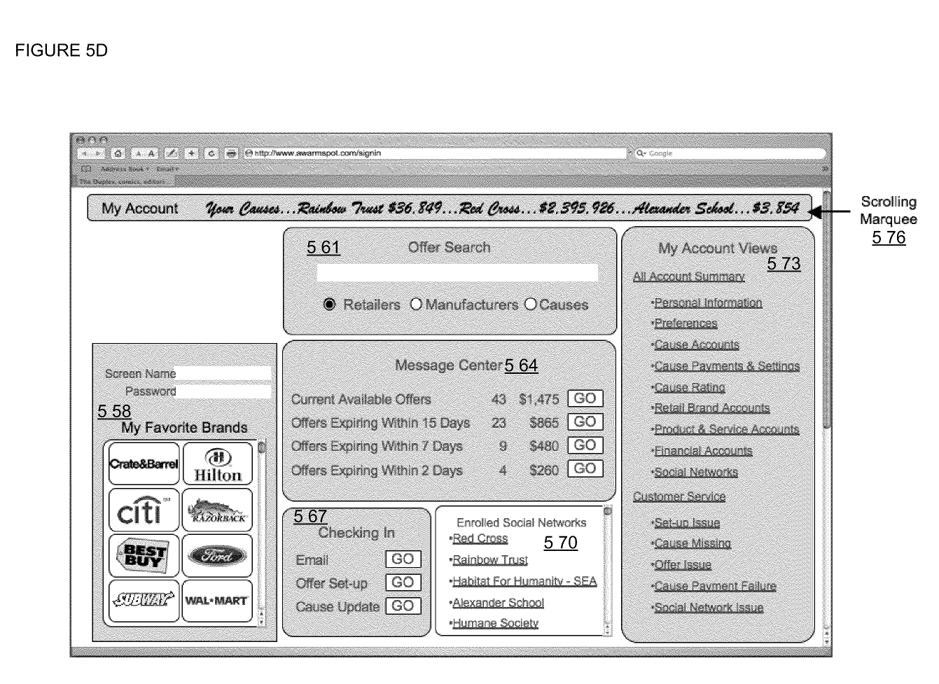

FIGS. 5A-D illustrate implementations of user interfaces for initial login and co-donor and/or consumer/donor registration in embodiments of Platform operation. In FIG. 5A is shown an initial log-in screen 501, wherein a Platform participant can enter information to be admitted access to the Platform website and/or Platform functionality, and/or to initiate a registration process for a new user. Having entered log-in information, the Platform may determine whether the user has already registered or not. If so, then the Platform matches to profile data and launches the page appropriate to that user (e.g., distinguishing between a cause 503, a brand 505, a co-donor 507, and/or a consumer/donor 509). If the user is unregistered, then the Platform may prompt the user to enter additional information in order to better understand the nature of the user and serve the appropriate page.

FIG. 5B shows a close up of one implementation of the consumer/donor registration page. The page includes a window to specify the account type 511, allowing a consumer/donor to select from a radio button menu including such options as “complete”, whereby the consumer/donor has complete access to offer-donation acceptance, co-donation, and other Platform functionalities; and “co-donation”, whereby the consumer/donor has access to co-donations, and some other Platform functionalities. Below this window is shown a window 513 wherein the consumer/donor may select causes to which donations may be made based on the consumer/donor's activities. A list of selected causes is shown below a text box where the names of causes may be entered. In one implementation, the entry of an unrecognized cause and/or a cause that is not registered with the Platform may trigger the initiation of a qualification process in the Platform whereby, for example, cause information is queried and compared to a set of qualification criteria. That information may, for example, include the cause's tax status. The interface may alternatively or in addition include a pull-down menu or other such listing of selectable cause names based on causes that are known or have registered with the Platform. There is also provided a clickable interface area 514 wherein a user may attach an image for their profile, such as a picture of him or herself.

In some embodiments, the Platform allows a consumer/donor to specify the destinations of donations made based on that consumer/donor's activities with considerable control and/or precision. The consumer/donor may, for example, set parameters defining the distribution of donations, such as time dependencies and/or limits for donation distributions to particular causes and/or groups of causes; total dollar amount limits for causes; percentage of total donations directed towards particular causes; and/or the like. Furthermore, as described above, some implementations may allow causes to separately register sub-divisions within their own activities (e.g., a national organization may have a page for itself and for each of its local chapters), and this affords the consumer/donor even greater control into exactly how the funds associated with his or her activities are to be distributed.

The consumer/donor registration page shown in FIG. 5B also includes areas in which the consumer/donor may select retail brands 515; manufacturing, product, and/or service brands 517; payment and/or payment facilitation brands 519; and/or the like with which the consumer has existing relationships and/or personal preferences. In one implementation, the brand selection interface may not be provided to the consumer/donor until after a sufficient amount of registration information is first received. In another implementation, the brand selection interface may include a brand name searching interface and/or a plurality of selectable and/or searchable brand categories, like retail stores, or major household categories of product brands, such as food, paper products, personal care, and/or the like. The consumer/donor may select a brand by clicking on the corresponding brand logo. Further details surrounding brand selection are provided below with reference to FIG. 5C. A listing of selected brands is displayed at the right of the interface 521, and includes a menu by which a consumer/donor may elect to add brands, delete previously selected brands, or update brands at some later time. Brands selected by the consumer/donor may determine and/or otherwise affect the types of offer-donations that are delivered to the consumer/donor at later times.

FIG. 5C shows further aspects of the brand selection interface in one embodiment of Platform operation. The consumer/donor selects a brand 523, such as from the retail 525, manufacturer 528, or payment 531 categories, and is subsequently presented with a logo box interface 532 corresponding to the selected brand. In one implementation, the brand logo interface element selected from FIG. 5B may enlarge and flip over to reveal the logo box interface at 532. Here, the consumer/donor may provide additional information regarding his or her relationship with the selected brand. For example, in the shown implementation, the consumer/donor may enter information pertaining to whether he or she is currently a customer of the brand 534, whether he or she is a brand account holder 537, a brand account number 540, whether he or she has a brand credit card account 543, a brand credit card account number 546, whether the brand is permitted to send the consumer/donor offer-donation notifications 549, and/or the like. The logo box interface further includes buttons 552 enabling the consumer/donor to continue to the brand selection page or to clear the existing logo box entries to make changes. The buttons 552 further include a “submit” button which, when clicked, causes the entered information to be verified with brand-established real-time links to the brand and/or brand website that validate the entered relationship status. Upon successful validation, the brands may make a donation in any amount to the consumer/donor's giving account and/or selected cause(s) of choice. Such a donation may, for example, be made as a reward for customer loyalty as reflected in the consumer/donor's account records with the brand. If the donated money is applied to the consumer/donor's generic giving account within the Platform, it may be later distributed to one or more causes of choice once the user has specified them. In one implementation, the donation may only be held in the giving account for a pre-set period of time (e.g., 30 days) before being returned to the brand if the consumer/donor fails to specify recipient causes in a timely fashion.

FIG. 5D shows an implementation of a consumer/donor homepage that may be displayed after the consumer/donor has completed an initial registration procedure. The page includes a listing of selected “favorite” brands 558. Entering a screen name and password in the fields provided may allow the consumer/donor to enter a page similar to FIGS. 5B and/or 5D in order to change his or selection of brands. The page also includes an offer search window 561, allowing the consumer-donor to search existing offer-donations. In the displayed implementation, the consumer-donor may select from a radio-button menu to search offer-donations associated with brands, manufacturers, or causes. Further details surrounding offer-donation searching are provided below. In addition to having the ability to search offer-donations, the Platform may supply a selection of targeted offer-donations directly to the consumer/donor, as may be accessed via the message center window 564. Here, a consumer/donor may access offer-donations and sees a breakdown of the number of currently available offer-donations, the potential donation value of those offer-donations, and how many expire at 15 day, 7 day, and 2 day intervals. A “checking in” window 567 includes links to Platform-mediated email, as well as to offer set-up, and to update personal causes. A listing of the consumer/donor's presently selected causes of choice is shown at 570. At 573 is a list of links to various account views and reports, including: an all account summary report, personal information, preferences, cause accounts, cause payments and settings, cause ratings, retail brand accounts, product and service accounts, financial accounts, social networks, and/or the like. The window also includes a selection of customer service links, including: general customer service, set-up issue assistance, cause missing assistance, offer-donation assistance, cause payment failure assistance, and social network issue assistance. Finally, a scrolling marquee is provided at the top of the interface 576, displaying the donation amounts made to the consumer/donor's selected charities. The marquee may, for example, display the donation amounts based solely on the consumer/donor's activities, based on the total amounts received from the cause's social network, based on a particular period of time, and/or the like.

### Co-Donation Setup

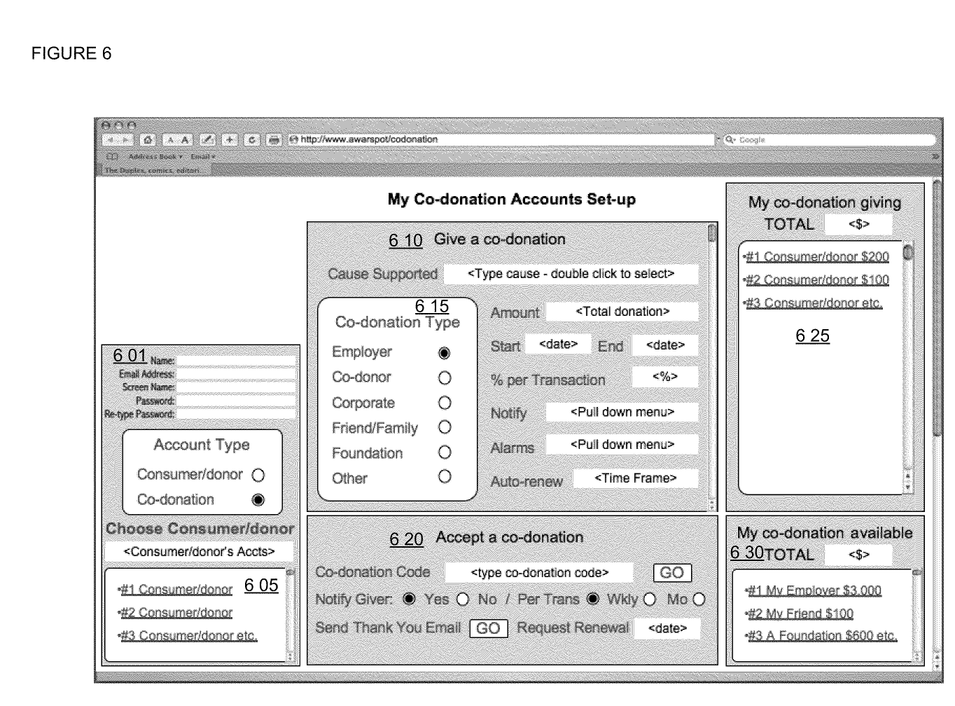

FIG. 6 shows an implementation of co-donation log in and setup in one embodiment of Platform operation. Consumer/donors and/or other Platform participants may elect to act as co-donors to provide donations based on the purchase activities between other consumer/donors and third-party brands. For example, a grandmother consumer/donor registered with the Platform may desire to donate $10.00 to the education fund of her grand-daughter's elementary school every time her daughter, also a Platform participant, purchases school supplies. Other Platform participants, besides consumer/donors, may act as co-donors as described below.

The interface includes a window 601 in which to enter login information. This information may be required to enter a page allowing the participant to edit his or her list of accepted co-donors, which are listed at 605. A window is provided at 610 for arranging to give a co-donation. This includes fields such as, but not limited to: a specification of the cause supported by the co-donation (a co-donor may, in some embodiments, elect to donate to any cause of his or her choice contingent upon the purchase activities of a consumer/donor, and need not necessarily choose any of the causes of choice of the consumer/donor actually making the purchases); an amount field, where the co-donor may specify an upper limit for the amount of money that he or she is willing to donate within the context of the co-donation; start and end date fields, setting the time boundaries for the co-donation; a percent per transaction field, in which the co-donor may specify the amount to donate as a percentage of the value of the targeted consumer/donor's transaction; a notification field, implemented as a pull-down menu, by which the co-donor may specify whether and how he or she wishes to be notified when a consumer/donor transaction triggers a co-donation event and/or when a particular co-donation nears a total donation limit; an alarms field, implemented as a pull-down menu, by which the co-donor may specify alarm levels and/or conditions at which he or she may be provided notification, such as when a particular co-donation commitment is approaching a pre-set donation limit; and an auto-renew field, implemented as a pull-down menu, by which a co-donor may specify a time-frame based on which the co-donation may be automatically renewed. There is also a window 615 to allow a co-donor to specify a co-donation type for the new co-donation. The displayed implementation includes a radio-button menu admitting co-donation type inputs including: employer, whereby an employer may, for example, agree to donate based on an employee's purchase and/or donation activities; co-donor, which may comprise a general co-donor category; corporate; friends/family, whereby friends and or family members of a consumer/donor may elect to make co-donations based on the consumer/donor's purchases and/or donations; foundation, whereby a foundation may elect to match funds and/or make donations based on a consumer/donor's purchases and/or donations; and other.

The interface also includes a window in which a consumer/donor may accept a co-donation offered by another Platform participant 620. The co-donation acceptance interface includes a number of fields and/or menus, including: a field in which to enter a co-donation code corresponding to the co-donation offer being accepted; a notify giver radio button menu, whereby a consumer/donor may specify whether the originator of the co-donation should be notified, notification frequency, and/or the like; a button to send a thank-you message to the co-donation originator; and a field in which to enter a date by which the consumer/donor would like to request renewal of the co-donation.

The interface also includes a window displaying the co-donation amounts that have been donated based on the consumer/donor's purchase activities and/or donations 625. The window includes a total donation amount, as well as a breakdown of donation amounts by the consumer/donors originating the co-donations. Below this window is a second window displaying the amounts of co-donations available to the consumer/donor and/or his or her causes of choice based on accepted co-donations 630. Again, there is displayed a total amount of available funds, as well as a breakdown of funds by the co-donors originating them.

### Offer Generation and Acceptance

FIG. 7 shows an implementation of combined data and logic flow for offer generation and acceptance in one embodiment of Platform operation. A retail brand 701, manufacturer brand 704, payment brand 707, and/or the like may interact with the Platform 710 to generate a brand offer-donation at 713. Further details surrounding offer-donation generation are provided below. The offer-donation may be provided to one or more causes who may elect to approve or reject the offer 716. If rejected, the offer-donation is not published by the cause and/or distributed by the cause to its members or members of its social network(s). If accepted, on the other hand, the cause may elect to publish the offer-donation and/or otherwise distribute a notice of the offer-donation to its members and/or social network participants. In an alternative implementation, causes are not asked to approve or reject offer-donations, and the offer-donations are matched directly to potentially interested consumer/donors based on offer-donation specifications and consumer/donor profiles.

The offer-donations may be publicized to consumer/donors by a wide variety of means, some of which are included in FIG. 7. Those displayed include presenting the offer-donations via email 725, via a webpage associated with a social network to which targeted consumer/donors may belong 728, via a search engine 731 (e.g., responsive to a search made by a consumer/donor), and as an advertisement 734, be it electronic, print, television, radio, and/or the like. A consumer/donor may encounter the offer-donation by any of these or other publication means and subsequently may elect to pursue any of a variety of different responses, some of which are provided in the figure. Those displayed include: doing nothing 737; accepting the offer-donation 740; not accepting the offer-donation, but still forwarding it to another consumer/donor for whom they may think the offer-donation may be attractive 743; and/or transacting the offer-donation 746 to be accepted by another consumer/donor 749. A second consumer/donor who receives a forwarded offer-donation, again, has the options of: doing nothing 752; accepting the offer-donation 755; not accepting the offer-donation, but still forwarding it to another consumer/donor for whom they may think the offer-donation may be attractive 758; and/or transacting the offer-donation 761 to be accepted by another consumer/donor 763.

In one implementation, transacting an offer-donation may comprise a first consumer/donor paying for the product and/or service to which the offer-donation is connected, receiving funds for his or her causes of choice based on that purchase, and subsequently selling the product and/or service to a second consumer/donor registered with the Platform. The transaction of selling the product and/or service to the second consumer/donor may, in one implementation, be mediated by the Platform in order to ensure, for example, that there is no inordinate markup being added to the product and/or service price.

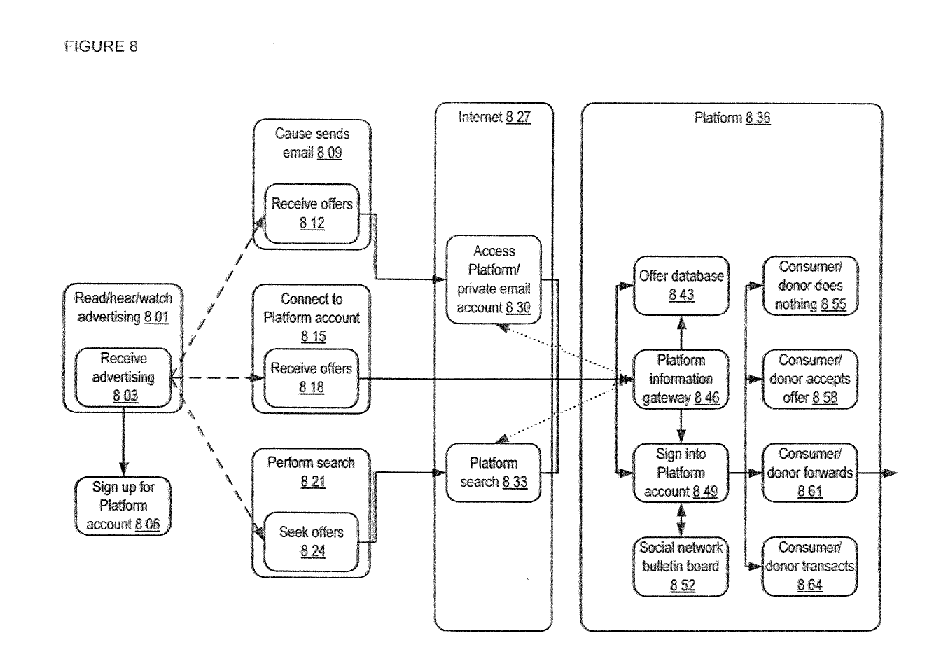

FIG. 8 shows an implementation of combined data and logic flow for offer-donation receipt and/or inquiry in another embodiment of Platform operation. People, whether Platform participants or not, may read, hear, or watch advertising 801 and receive advertising pertaining to one or more Platform affiliated offer-donations 803. If not a registered Platform participant, those people may sign up for a Platform account 806. For registered consumer/donors, there are a number of different ways in which the Platform may supply offer-donation information, some of which are shown in FIG. 8. Those displayed include receiving an offer-donation 812 within an email from a cause 809, being presented an offer-donation 818 when connecting to a Platform account 815, and seeking offer-donations 824 when performing an internet search using a search engine 821.

An offer-donation received by email 812 may, for example, be received via an Internet 827 coupled registered Platform email account, and/or may link the consumer/donor directly to his or her personal Platform account 830. A consumer/donor seeking out offer-donations 824 may employ Platform search tools and/or link to his or her Platform account via the search results page to secure the offer-donation. A consumer/donor may also access the offer-donation through a Platform gateway 846 by signing into his or her Platform account 849 to view his or her social networks and/or bulletin boards 852, query an offer database 843, request specific offers, check his or her Platform email account, perform Platform mediated searches, and/or the like. Once an offer-donation is matched with and provided to a consumer/donor, there are a number of options available to the consumer/donor, some of which may include: doing nothing 855; accepting the offer-donation 858; not accepting the offer-donation, but still forwarding it to another consumer/donor for whom they may think the offer-donation may be attractive 861; and/or transacting the offer-donation 864.

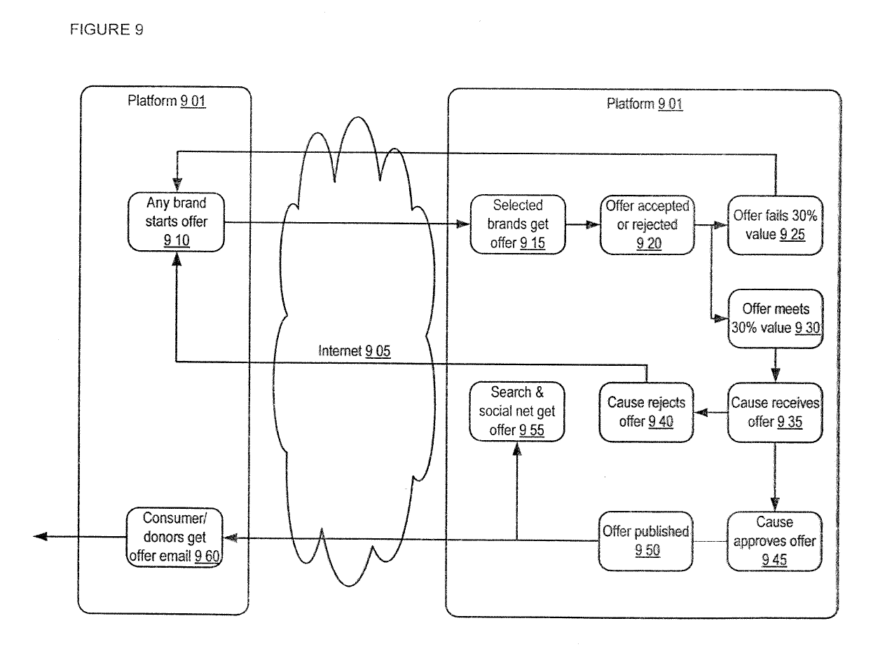

FIG. 9 shows an implementation of combined data and logic flow for offer-donation creation in another embodiment of Platform operation, wherein Platform 901 components interact through and in conjunction with the internet 905. Any brand begins creation of an offer-donation 910, which may include other selected retail, manufacturer, or payment brands. The other selected brands receive the notification that they have been included in the offer-donation 915 and are provided the opportunity to accept or reject participation in the offer-donation 920. The offer is then checked to determine whether it meets a minimum criteria of value for the consumer/donors to which it may be directed. This may comprise, for example, a check of whether the amount of the offer-donation exceeds a minimum threshold proportion (e.g., 30%) of the retail purchase price of products and/or services associated with the offer-donation. If the offer-donation fails to meet the value criteria 925, then the offer-donation may be rejected by the Platform and/or a notice may be returned to the originating brand that an increased value is required. If, on the other hand, the offer-donation meets the value criteria, 930, then it may be supplied to at least one cause to which the offer-donation is directed 935. The cause may then be provided the opportunity to accept or reject the offer-donation. If rejected by the cause 940, the rejection may be reported to the participating brands. If accepted by the cause 945, then the offer-donation is published 950. The offer-donation may be incorporated into a Platform offer-donation database and catalogued within a Platform search index, as well as provided for publication within the appropriate Platform social networks 955. The offer-donation may also be supplied to targeted consumer/donors via email 960.

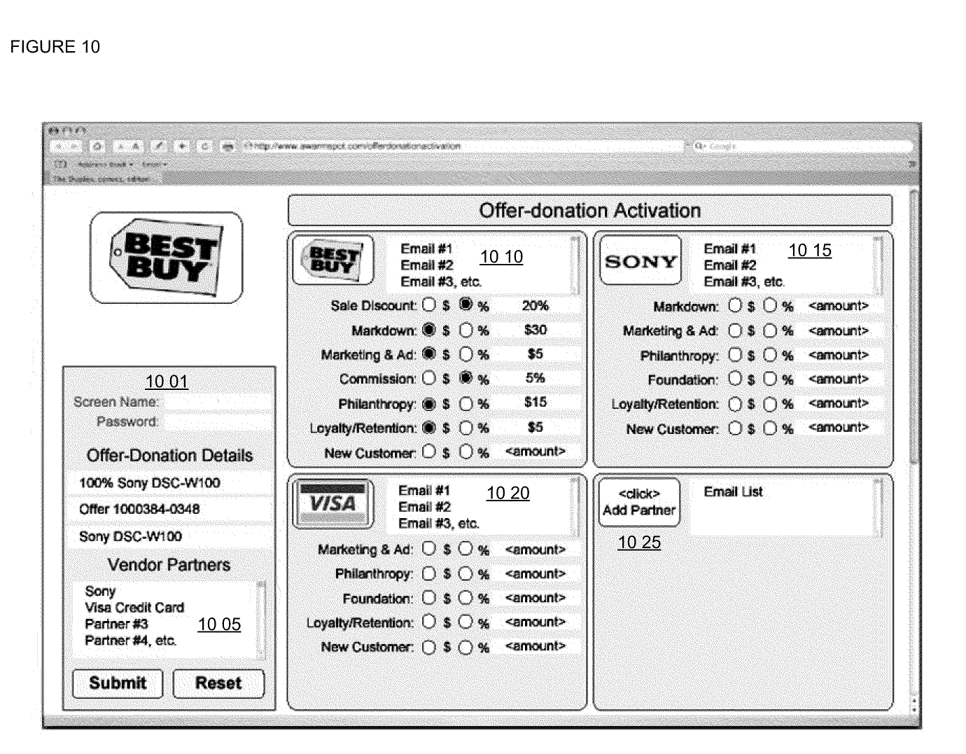

FIG. 10 shows an implementation of a user interface for generating and/or activating an offer-donation in one embodiment of Platform operation. In the particular implementation shown, a retail brand is creating an offer-donation seeking participation of at least one manufacturer brand and at least one payment brand. The interface includes a window 1001 wherein the originating brand (in this case the retail brand) may enter offer-donation details such as an offer-donation name, ID, associated product, keywords and/or search terms, and/or the like. The window further includes an area 1005 listing additional brands invited by the originating brand to partner in the offer-donation. These brands each have a corresponding window in the interface, here including the originating retail brand 1010, an invited manufacturer brand 1015, and an invited payment brand 1020. In the displayed interface, there is included a clickable element 1025 to invite additional partner brands. Clicking on the element may, in one implementation, generate a window listing brands registered with the Platform and/or allowing the originating brand to enter a name, contact information, and/or the like for an invited brand. Each window corresponding to an offer-donation partner includes an area listing email addresses for that brand as well as fields wherein the brand (initially the originating brand) may enter parameters characterizing the value proposition of the offer-donation. These may, for example, include a sales discount, markdown, marketing and/or advertising contribution, commission, philanthropic contribution, loyalty and/or retention contribution, a new customer donation benefit, and/or the like. In one implementation, the originating brand may determine the number and/or types of donation fields available to any or all of the invited partner brands. Any or all of the fields may admit either a fixed dollar amount and/or a percentage of the total purchase price. In one implementation, the fields may admit a percentage of the total purchase price as well as a total dollar amount limit, either per transaction or for the overall donation made by the brand for that parameter within the offer-donation.

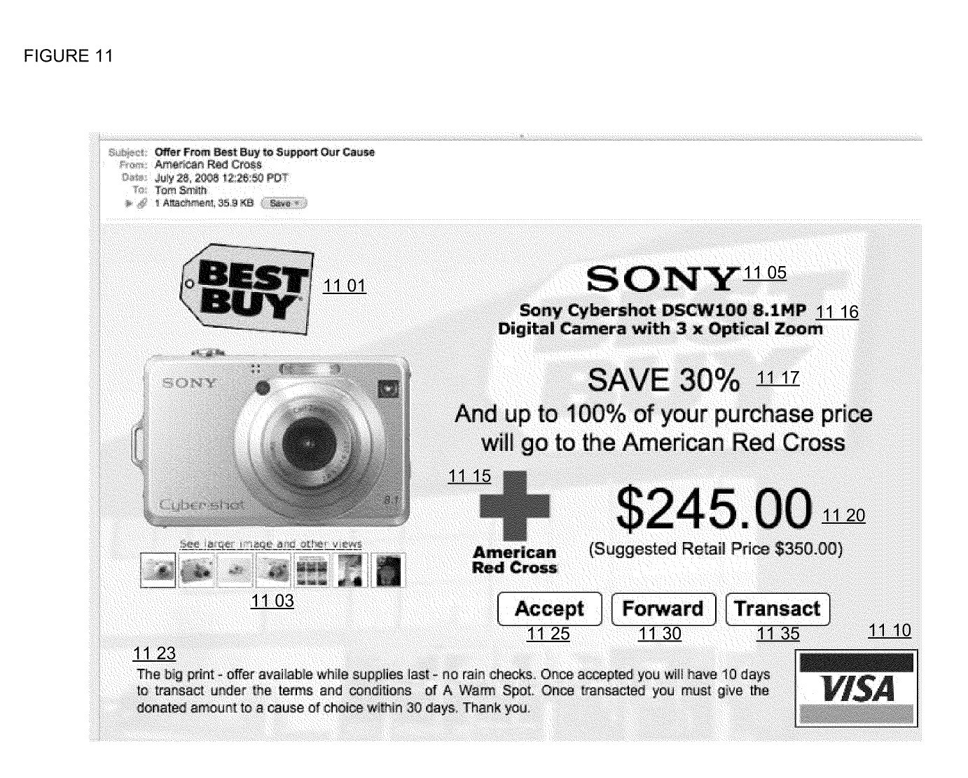

FIG. 11 shows an implementation of an offer-donation manifested as an email message in one embodiment of Platform operation. The message may be used to notify a Platform participant, in particular a consumer/donor, of an existing offer-donation of possible interest to him or her. The message includes logos corresponding to each of the participating brands, including the originating retail brand 1101, a manufacturer brand 1105, and a payment brand 1110. The message further includes a logo for one or more of the causes of choice 1115 of the consumer/donor to which the message is sent, thus drawing his or her attention to the potential benefit that his or her causes of choice may receive as a result of accepting the offer-donation. The message further includes information surrounding the products and/or services to which the offer-donation is connected, including but not limited to: images showcasing several views of the product 1103 are included; a product description 1116; a description of discounts and/or donation amounts receivable as a result of accepting and/or fulfilling the offer-donation 1117; a product price 1120; offer-donation terms and conditions 1123; and/or the like. The displayed implementation also includes three buttons allowing the consumer/donor to initiate acceptance 1125, forwarding 1130, or transacting 1135 of the offer-donation with a single click from within the email.

In an alternative implementation, a number of different offer donations may be consolidated into an offer-donation catalog. Such a catalog may comprise a collection of offer-donations, products, services, advertisements, and/or the like that are targeted to the particular consumer/donor to which the catalog is provided. For example, in one implementation the offer-donation catalog may contain only offer-donations, products, services, advertisements, and/or the like originated by brands selected by the consumer/donor during the consumer/donor registration process. In other implementations, contents of the offer-donation catalog may further be filtered based on: specifications made by a consumer/donor's cause(s) of choice (e.g., if a consumer/donor belongs to PETA, he or she may not receive offer-donations in his or her offer-donation catalog related to the purchase of fur coats); the consumer/donor's personal specifications (e.g., a consumer donor may specify that he or she desires only to receive offer-donations related to grocery items); the consumer/donor's offer-donation selection and/or shopping history; relationships between the consumer/donor's selected brands and other brands (e.g., an offer-donation from a brand not in the consumer/donor's list of selected brands may be supplied under an agreement with a brand from that list); a consumer/donor's loyalty relationship with brands (e.g., special offer-donations may be provided for a user who has held a brand credit account for a sufficiently long period of time); and/or the like. The offer-donation catalog, thus, comprises a highly dynamic compendium of opportunities that is tailored for and targeted to the particular consumer/donor to which the catalog is supplied. In various implementations, the offer-donation catalog may be provided to the consumer/donor within the context of a variety of different types of media, such as an email message, a web page (e.g., linked from the consumer/donor's Platform homepage), a popup, a paper book, an electronic storage medium (e.g., a CD or DVD), an electromagnetic carrier signal, and/or the like.

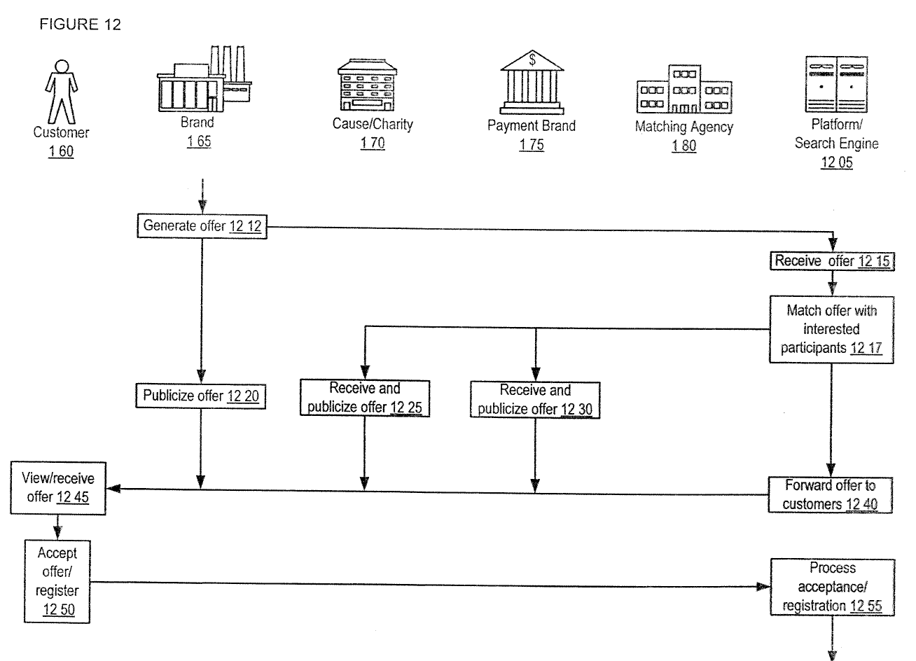

FIG. 12 shows an implementation of logic flow for offer generation and acceptance within an alternative embodiment of Platform operation. A brand and/or group of brands may generate an offer at 1212. The Platform receives the offer at 1215. In one implementation, elements of the Platform may be configured to inspect received offers to ensure that they adhere to a set of offer standards and/or guidelines prior to further processing. In another implementation, elements of the Platform may be configured to glean relevant offer data from an offer text file or other unstructured offer submission. Non-compliant offers may be flagged, rejected, and/or returned to submitting users with suggestions on how they might be made to comply. Offer compliance may be established, for example, by comparing offer contents with a set of required offer fields to determine whether a submission contains all of the required offer information. Acceptable offers are processed, such as via the matching engine 1217, to determine which Platform participants, including customers, matching agencies, other retail brands, manufacturer brands, payment brands, charities and causes, and/or the like may be interested in the offers 1240. This may be accomplished, for example, by comparing a set of interest keywords contained in a participant profile to a set of offer descriptors. In one implementation, the Platform may notify matched retail brands, manufacturer brands, charities, causes, payment brands, matching fund agencies, and/or the like of the offer and provide an opportunity to participate.

In one embodiment, the XML for an offer may take a form similar to the following example:

<offer ID = “offer12345”>

<name> Soda Discount </name>
<products>

<product1>

<SKU> 00-343 </SKU>
<price_adj> 10% donation </price_adj>

</product1>
<product2>

<SKU> 00-344 </SKU>
<price_adj> 10% donation </price_adj>

</product2>
<product3>

<SKU> 00-350 </SKU>
<price_adj> 20% donation </price_adj>
<restriction> Valid before 6/6/07 </restriction>

</product3>

</products>
<offer_dates>

<begin> 5/1/07 </begin>
<end> 6/30/07 </end>

</offer_dates>
<description>

<img> sodacan.jpg </img>
<desc>

This offer provides a donation to your favorite charity
of 10% of the purchase price for Soda A and Soda B, or
of 20% of the purchase price for a limited edition soda
flavor (Soda C) that is available until June 6, 2007.

</desc>

</description>
<terms>

Customer agrees to purchase at least one can of Soda A, Soda
B, and/or Soda C using a pre-specified payment method in
exchange for having a pre-specified portion of the purchase
amount donated to the customer's one or more causes and/or
charities of choice. The donation amount for Sodas A and B
are both 10% of the purchase price and are unrestricted within
the dates of offer validity. The donation amount for Soda C is
20% of the purchase price, and is valid only between the offer
start date and June 6, 2007. Limit 3 offer acceptances per
customer ID. Offer valid between May 1, 2007, and June 30,
2007.

</terms>
<tags>

soda; flavors; Soda A; Soda B; Soda C

</tags>

</offer>

In the above data structure, the offer itself is identified by an offer ID, and an offer name field is further included. A products field specifies product identifying information, associated price adjustments, and/or additional restrictions for qualifying products under the offer terms. An offer dates field specifies the beginning and ending dates of offer validity (e.g., dates between which any and all qualifying transactions must be conducted). A description field specifies information, image files, and/or the like that is for display to the user in offer advertisements, publications, and/or the like. A terms field includes the specific terms, conditions, restrictions, and/or the like associated with the offer, such as may be displayed in a “Terms and Restrictions” window to the user prior to solicitation of a user offer acceptance. Finally, a tags field specifies a number of tags, keywords, phrases, and/or the like which may serve to assist Platform users in searching for offers by means of search terms.

Approved offers may be publicized by the brand directly 1220 and/or distributed to other agencies and organizations that have been deemed as matches at 1217, in order to provide them with the opportunity to participate in the offers. Participating agencies and organizations, then, may elect to publicize the offer (1225 and 1230) via a variety of different means such as advertisements, announcements, newsletters, emails, and/or the like to organization members or other potential customers for whom they deem the offers suitable. The Platform itself may also publicize the offer, incorporate the offer into a searchable index of offers, directly forward the offer to matching customers 1240, such as via email notifications, and/or the like. Customers, in turn, view offers to which they are exposed and, possibly, decide to accept particular offers in which they are interested 1245. Customers may be passively exposed to offers, such as via advertisements or targeted notifications. Customers may also be actively exposed to offers while conducting a search. For example, a customer may search for offers related to a particular product, brand, type of product, and/or the like, and may receive relevant listings in return. Desirable offers may be accepted by the customer at 1250. Non-registered customers who are interested in accepting an offer may be requested to register with the Platform at this stage. At 1255, the Platform receives and processes customer offer acceptances and/or any accompanying user registration information.

### Offer Fulfillment

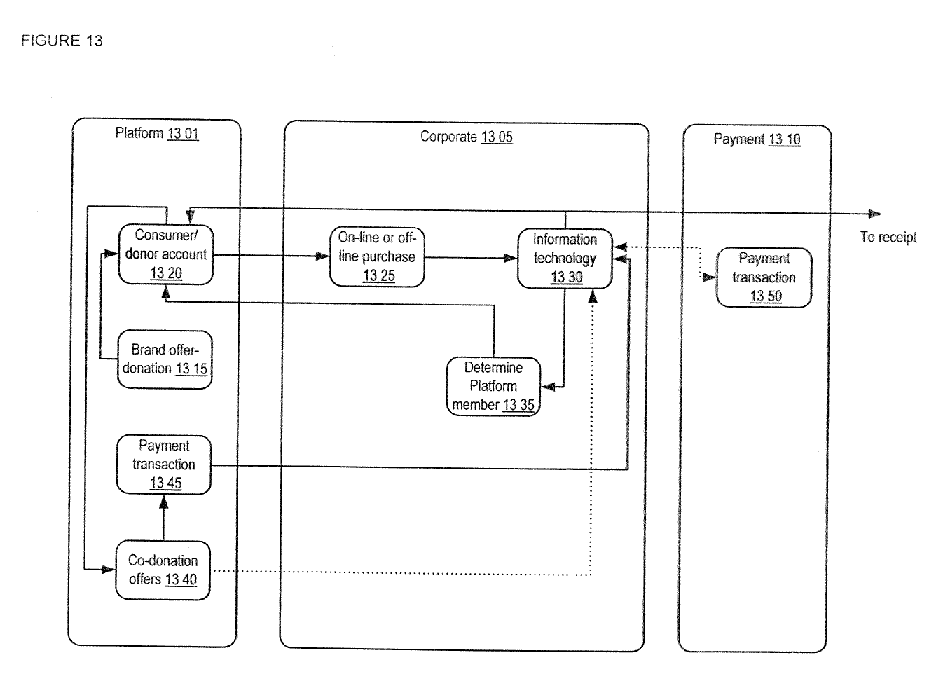

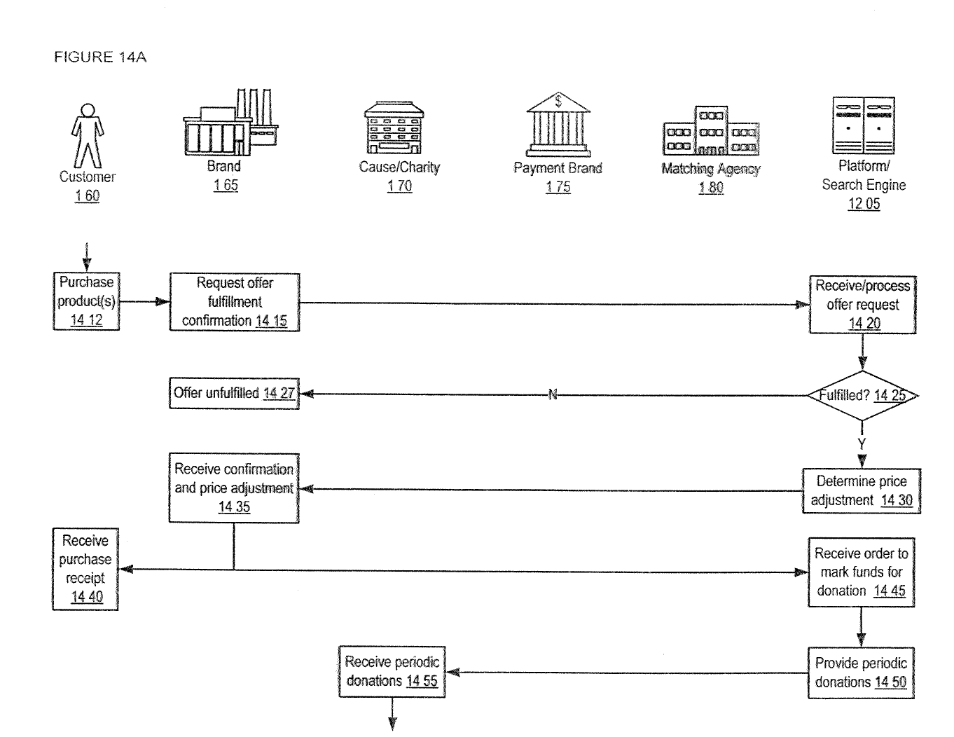

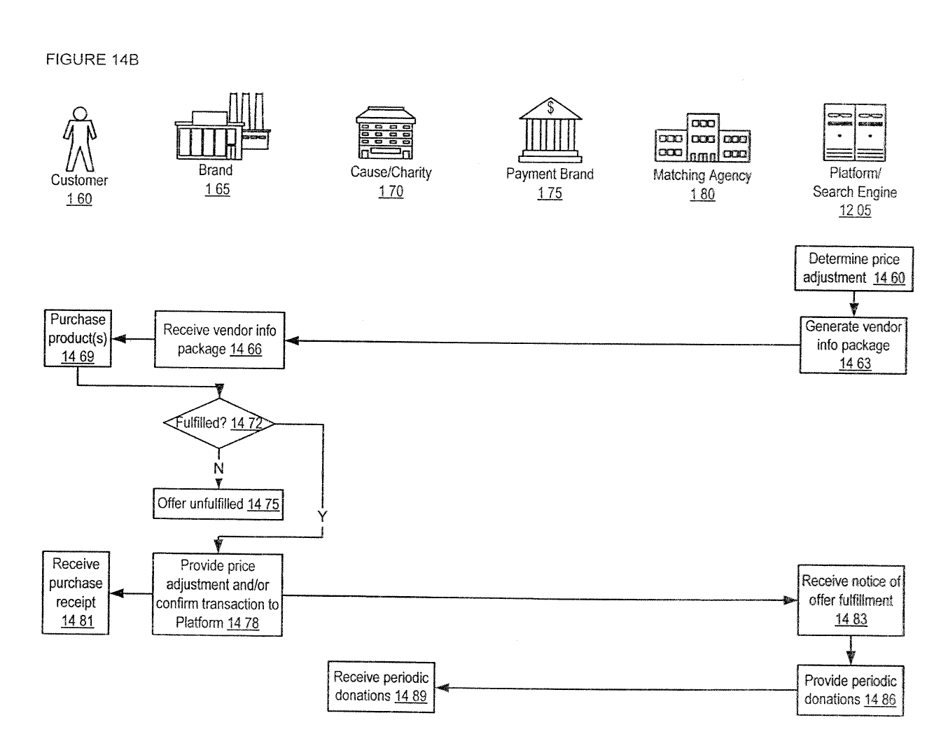

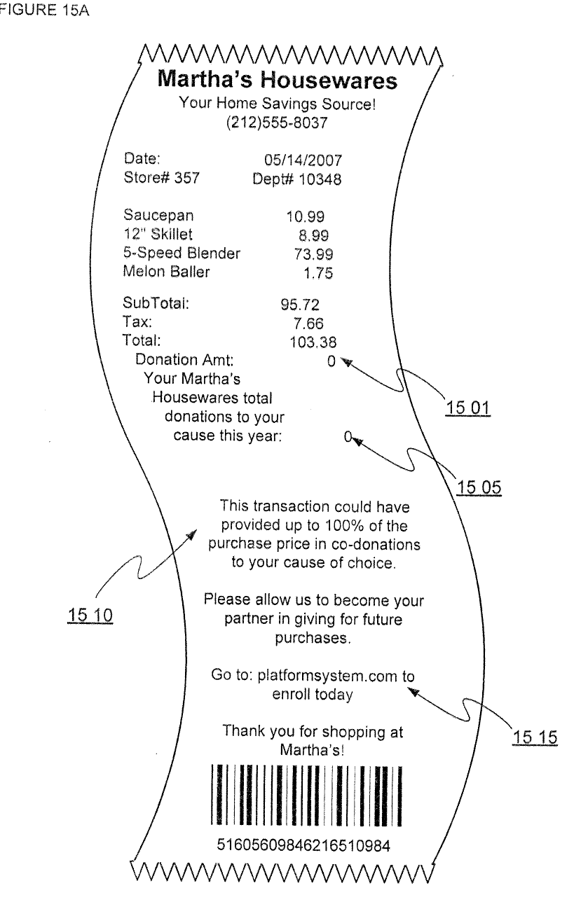

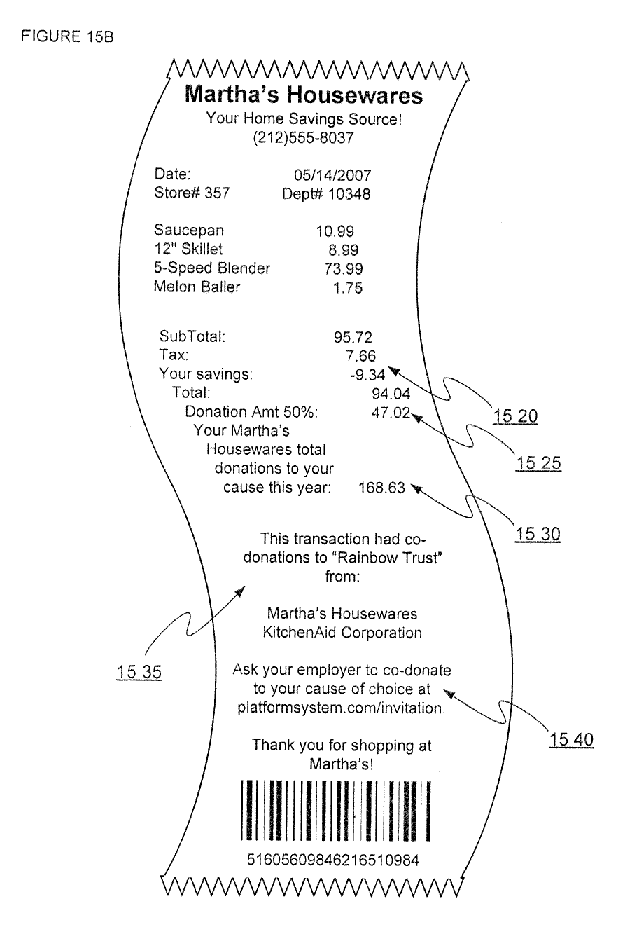

FIG. 13 shows an implementation of offer fulfillment in one embodiment of Platform operation, describing interactions between the Platform 1301, corporate and/or retailer technology 1305, and/or payment facilitation technology 1310. A brand generates an offer-donation 1315 which is made available to a consumer/donor via a consumer/donor account 1320 within the Platform 1301. Subsequently, the consumer/donor makes a purchase in attempted compliance with offer-donation terms 1325. The purchase may either be made online (e.g., via a retailer website, linked from the Platform, etc.) or offline. Offline purchases may, in one implementation, be divided into two categorizations: on-network purchases, wherein the retailer may interface with Platform functionality directly from the POS (e.g., via an intelligent cash register system), and off-network purchases, wherein the retailer cannot interface with Platform functionality but the payment facilitation method used by the consumer/donor in making the purchase can cause the payment brand to interface with the Platform.

The solid lines detail the flow for an implementation involving an on-network retailer. Once the transaction is made, corporate information technology 1330 is employed to interrogate the transaction characteristics in order to determine whether the offer-donation terms and/or conditions were successfully fulfilled. This may, for example, comprise querying the SKU number of the purchased product and/or the credit card number and/or the like of the payment facilitation means employed by the consumer/donor to make the purchase. The corporate information technology may interact with the Platform in order to exchange information pertaining to offer terms, payment facilitation information, product information, and/or the like in order to determine whether the terms have been successfully fulfilled 1335. If so, the offer-donation information is compiled, along with applicable co-donation information 1340 specified within the consumer/donor account. Payment capabilities internal to the Platform are activated 1345 and a donation information package and donation confirmation are supplied to the POS for inclusion in a printed receipt. The consumer/donor's account may also be updated with the new offer-donation fulfillment information.

The dotted lines show an alternative implementation wherein the retailer is an off-network retailer. In this implementation, no internal payment is applied. Instead, the transaction information is supplied to a payment facilitator who settles the transaction, including applicable redistributions of funds, externally 1350.

FIGS. 14A-B show implementations of offer fulfillment in alternative embodiments of Platform operation. FIG. 14A shows an implementation in which a customer has accepted an offer wherein he or she agrees to purchase one or more products in exchange for having a portion of the purchase price donated to his or her charity or cause of choice, and the brand from which the purchase is made seeks offer fulfillment confirmation from the Platform. At 1412, a customer purchases the one or more products, in accordance with the offer terms, from a brand, who may subsequently submit a request for offer fulfillment confirmation 1415 to the Platform.

The Platform receives and processes the offer fulfillment confirmation request at 1420. This may be accomplished by a variety of different means within various implementations and/or embodiments of Platform operation. In one implementation, the Platform may receive both a customer identification and a product identification that may be used, in light of a stored set of offer terms and/or other information pertinent to the customer action, to determine whether the offer terms have been successfully satisfied. For example, if an offer specifies that registered customers who purchase a product manufactured by Company XYZ between June 10 and June 25 will have 10% donated to their charity of choice, then a given confirmation request may include a customer identification (to confirm that the customer has registered for and/or otherwise accepted the offer), a product brand identification, and a date of purchase, which may each be compared against allowed values to determine whether the particular transaction indeed satisfies the offer terms. In another example, an offer may specify that registered customers may receive a particular free product at Brand ABC on a pre-specified date in exchange for donating at least a minimum amount of money to a charity of the customer's choice. Consequently, offer fulfillment may be confirmed based on a comparison of customer identification, donation confirmation, product identification, and a date of purchase against allowed values.

The Platform makes a determination of offer fulfillment at 1425 and, if the offer is not fulfilled, may return a notice of non-fulfillment to a brand at 1427. On the other hand, for a successful offer fulfillment, the Platform may determine a price adjustment at 1430, which specifies a portion of the total purchase amount that is to be reallocated from the brand to one or more other participating Platform entities. In the example of Company XYZ above, the price adjustment for satisfactory offer fulfillment would establish that 10% of the purchase price be allocated to the customer's charity of choice. In the example of Brand ABC above, the price adjustment for satisfactory offer fulfillment would establish that 100% of the purchase price be allocated to the customer (i.e., the product would be free). A confirmation of offer fulfillment and/or associated price adjustment is relayed to the brand, who receives them at 1435. The customer is provided with a purchase receipt at 1440, which may include information regarding the size of the price adjustment, the allocation of the customer's payment, and/or the like. The Platform may receive an order to mark funds for donation to the customer selected charity 1445 and will provide periodic donations 1450 to be received 1455 by the various charities to whom funds are owed.

FIG. 14B shows another implementation of offer fulfillment wherein a customer agrees to purchase one or more products in exchange for having a portion of the purchase price donated to his or her charity or cause of choice. However, in this case the Platform provides the brand with a “brand capsule” that encapsulates the necessary information for the brand to confirm offer fulfillment and produce any necessary price adjustments on site. At 1460, the Platform determines an appropriate price adjustment based on the terms, conditions, restrictions, and/or the like specified in the offer. In one implementation, the Platform may determine a collection of price adjustments based on different customer, brand, and/or purchase contingencies, such as may be embodied within a price adjustment table. The Platform generates a “brand information capsule” at 1463, containing the one or more price adjustment data along with any other data necessary for the brand to determine whether offer terms have been successfully fulfilled by a particular customer, transaction or group of transactions, donation, and/or the like. Those data may, for example, include customer identifications (IDs) for participating and/or registered customers, customer profile information, product IDs (e.g., SKU, Universal Product Code, European Article Number, Global Trade Item Number, and/or the like), offer terms, customer purchase and/or donation histories, and/or the like. In one implementation, the information contained in the brand information capsule is sufficient to allow for an automated determination of offer fulfillment and/or appropriate price adjustments.

The brand receives the brand information package at 1466. In one implementation, the package is incorporated into a POS software application, which may be configured to run locally or may be accessed and/or manipulated via a communications network such as the internet. Once the brand information package has been received, the brand need only wait for a customer purchasing an item to seek offer fulfillment. If such a customer purchases a product 1469, the brand may determine whether that purchase fulfills the offer at 1472. That determination may be made, for example, by collecting user identification information (e.g., from a credit card number or other method of purchase), collecting product identification information (e.g., from scanning a product barcode), and/or any other information pertinent to the fulfillment of the particular offer. The collected information may then be compared against the conditions and/or requirements embodied in the brand information package to establish whether the offer has been successfully fulfilled. If so, the brand information package may also provide sufficient information to establish an appropriate price adjustment for the transaction in question.

In one embodiment, the XML for a brand information capsule generated by the Platform may take a form similar to the following example:

<capsule ID = “capsule 12345”>

<customers>

<customer1>

Vista 5432-1098-7654-3210 exp 9/09

</customer1>
<customer2>

Discovery 5678-9012-3456-7890 exp 7/08

</customer2>

</customers>
<product>

<product1>

<SKU> 00-343 </SKU>
<price_adj> 10% donation </price_adj>

</product1>
<product2>

<SKU> 00-344 </SKU>
<price_adj> 10% donation </price_adj>

</product2>
<product3>

<SKU> 00-350 </SKU>
<price_adj> 20% donation </price_adj>
<restriction> Valid before 6/6/07 </restriction>

</product3>

</product>
<offer info>

<ID> offer12345 </ID>
<name> Soda Discount </name>
<begin> 5/1/07 </begin>
<end> 6/30/07 </end>

</offer_info>

</capsule>

In the above data structure, the capsule itself is identified by an ID. The customers field shows identification information, in this case credit card information, for customers who have accepted the offer. The product field shows product identification information, in this case SKU codes, for products that qualify under the offer terms. In addition, the data structure indicates the price adjustment associated with each product. Thus, if a purchase of a product with SKU code 00-343 is made with a Vista credit card bearing the number 5432-1098-7654-3210 exp 9/09, the brand's POS software may determine that 10% of the product price should be set aside for donation. The entry for product3, with SKU code 00-350, includes an additional restriction field that specifies a rule on what dates this product qualifies for offer fulfillment. Finally, the offer info field specifies the offer information, such as offer ID, offer name, and beginning aid ending dates for offer validity.

If the circumstances of the transaction fail to satisfy the offer fulfillment requirements, then the offer is left unfulfilled 1475 and no Platform generated price adjustment is applied. On the other hand, if the requirements embodied in the brand information capsule are fulfilled by the transaction circumstances, then the applicable offer terms are applied by the brand to the customer's purchase 1478 and reflected on the customer's receipt 1481. These offer terms may vary depending on the particular offer and may include, for example, an instant or mail-in rebate, provision of a free item or items, a discount, a donation, and/or the like. The brand may also provide a confirmation of offer fulfillment to the Platform, which is received by the Platform at 1483. Depending on the nature of the offer, the Platform may provide periodic donations 1486 to the customer designated causes and/or charities in response to a successful offer fulfillment, which may subsequently be received by the causes and/or charities at 1489. For example, an offer pertaining to the provision of a portion of a product's purchase price to a customer's charity of choice may include a step to direct the Platform to allocate and/or distribute funds to that charity. In an alternative example, however, an offer may pertain to the provision of a free item to the customer in exchange for a customer donation to one or more charities. In this latter example, the Platform would have no call to donate to the charities as a consequence of offer fulfillment, and the brand may not even report the offer fulfillment to the Platform, except perhaps for the sake of transaction tracking.

In one embodiment, Platform administrators may charge a fee based on services provided to Platform participants in mediating transactions and coordinating payments of donations to selected causes and/or charities. Various fee structures may be implemented, depending on the particular needs and/or goals of a particular application of the Platform. For example, a fee may be charged as a percentage of the purchase price of a product associated with fulfillment of an offer for each transaction. In an alternative embodiment, no fee is charged for mediating transactions and coordinating payments of donations by brands, payment brands, matching fund agencies, and/or the like to selected causes and/or charities based on customer purchases.

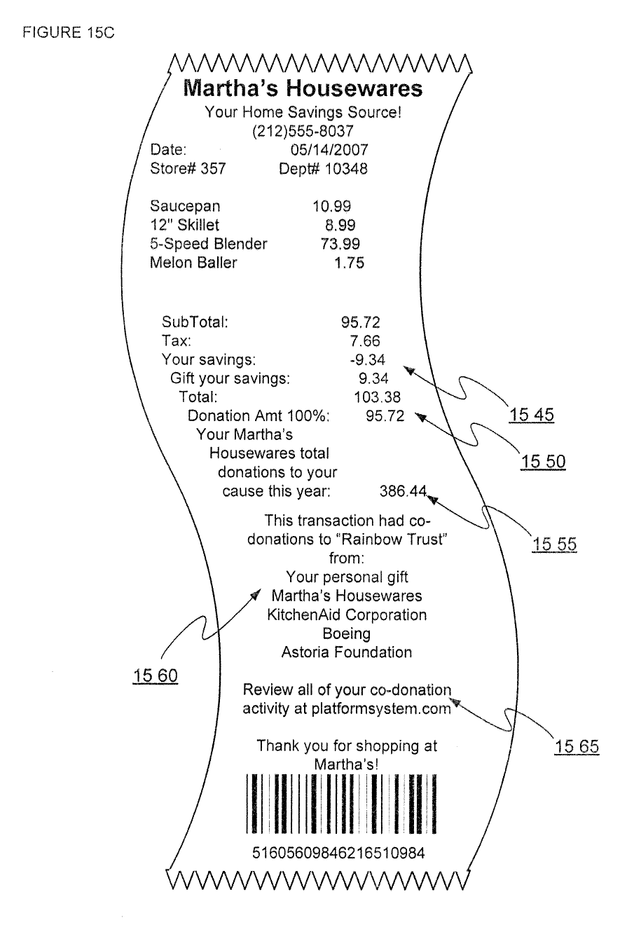

FIGS. 15A-C show customer purchase receipts for on-network purchases indicating Platform coordinated donation amounts in some embodiments of Platform operation. In FIG. 15A, the consumer/donor has not accepted an offer/donation connected to one or more purchased products and/or is not registered with the Platform. Consequently, a displayed donation amount corresponding to the transaction 1501 and an overall donation amount through all purchases with this retailer 1505 are both zero. The receipt includes a message 1510 informing the consumer/donor of the donation possibilities and/or benefits of registering with the Platform and provides information, such as a website address, to assist the consumer/donor in registering 1515.

In FIG. 15B, the consumer/donor is a registered Platform participant and has successfully fulfilled terms and/or conditions of an offer-donation with the purchases reflected in the receipt, thus earning donations from an offer-donation originator and an offer-donation partner. Consequently, a number of donations and/or price adjustments are applied. For example, the consumer/donor has received a personal savings of $9.34 over the total purchase price 1520. In addition, an amount of $47.02 has been donated to the consumer/donor's cause of choice based on this transaction 1525, adding to a total contribution of $168.63 for the year 1530. The receipt further indicates the entities from which donations were received 1535, which in this case include the retail brand as well as a manufacturer brand corresponding to one or more of the purchased items. Finally, there is a message 1540 encouraging the consumer/donor to ask his or her employer to register for the Platform in order to participate in a co-donation capacity.

In FIG. 15C, the consumer/donor is again a registered Platform participant who has successfully fulfilled terms and/or conditions of an offer-donation, however there are a number of differences with the receipt shown in FIG. 15B. First, though the consumer/donor has received the same personal savings of $9.34 as in the previous receipt, he or she has opted here to gift that savings back to his or her cause of choice 1545. The donation amount 1550 for the displayed transaction has now risen to 100% of the purchase price, and the total amount donated for the year 1555 has risen accordingly as well. This is due to the presence of additional donations, listed at 1560, which now include the personal savings donation and co-donations on top of the existing offer-donation amounts supplied by the retail and manufacturer brands. This receipt includes a message 1565 informing the consumer/donor about co-donation activity reports available on the Platform website.

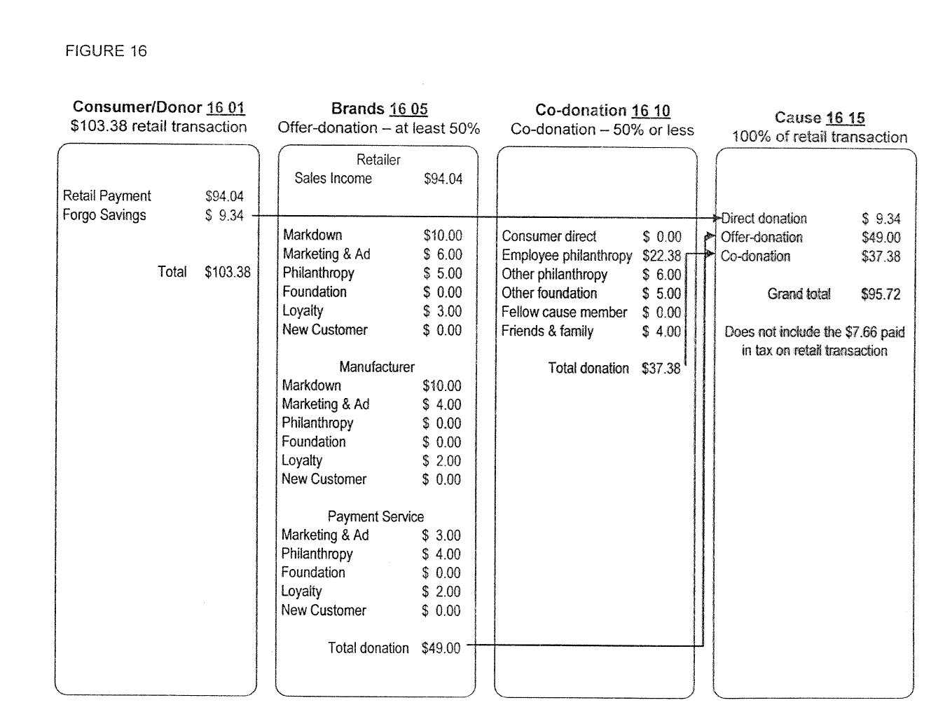

FIG. 16 shows an accounting breakdown of the funds and donations underlying the receipt shown in FIG. 15C. The consumer/donor 1601 ultimately spends $103.38 for the transaction, of which $94.04 is the actual retail payment and $9.34 is the amount of personal savings that he or she has decided to forgo by gifting to his or her cause of choice. The receipts and contributions of the various brands are shown at 1605. The column subtitle indicates that, in this implementation, the amount of donation made by the brands within the offer-donation should be within 30-50% of the retail payment price paid by the consumer/donor for the products and/or services under the offer-donation. Actual limits may vary within different implementations and applications of the Platform. Setting such limits allows the Platform to define standards of minimum and maximum value for offer-donations, beyond which offer-donations may be deemed unacceptable. In some implementations, brands may select an offer-donation value based on a consumer/donor's brand loyalty relationship with the brand. For example, an advertisement may be provided to a number of consumer/donors publicizing an offer-donation professing to provide at least 30% of the purchase price of a product to a consumer/donor's cause of choice. When a particular consumer/donor accepts the offer-donation, the brand and/or Platform may query the consumer/donor profile to determine what existing loyalty relationship the consumer/donor has with the brand providing the offer-donation. If the consumer/donor is deemed qualified, such as if the consumer/donor has a demonstrated record of loyalty (e.g., is a member of a “gold” or “premium” loyalty and/or rewards program with the brand, has participated in a large number of offer-donations with the brand, and/or the like), an even larger donation benefit may be provided to the consumer/donor's cause of choice than that initially advertised.

In the brand column in FIG. 16, the retail brand receives a sales income of $94.04, corresponding to the consumer/donor's retail payment. In turn, the retail brand may provide a markdown, marketing and advertising contribution, philanthropy contribution, contribution from an affiliated charitable foundation, a loyalty reward, a new customer reward, and/or the like. Similar classes of contributions and rewards may be provided by the manufacturer brand and/or the payment brand as well, ultimately resulting in a total offer-donation contribution of $49.00. On top of these donations, there are also provided co-donations 1610 directed to the specific consumer/donor. In the present case, these include donations directly from the consumer, from an employee philanthropy program (e.g., matched by an employer), other philanthropic matching, matching by other foundations, matching by another consumer/donor affiliated with the same cause, friends and/or family members, and/or the like. The total amount of co-donations in the present case sums to $37.38. Adding all these varied contributions yields the total contribution supplied to the cause 1615, which amounts to $95.72.

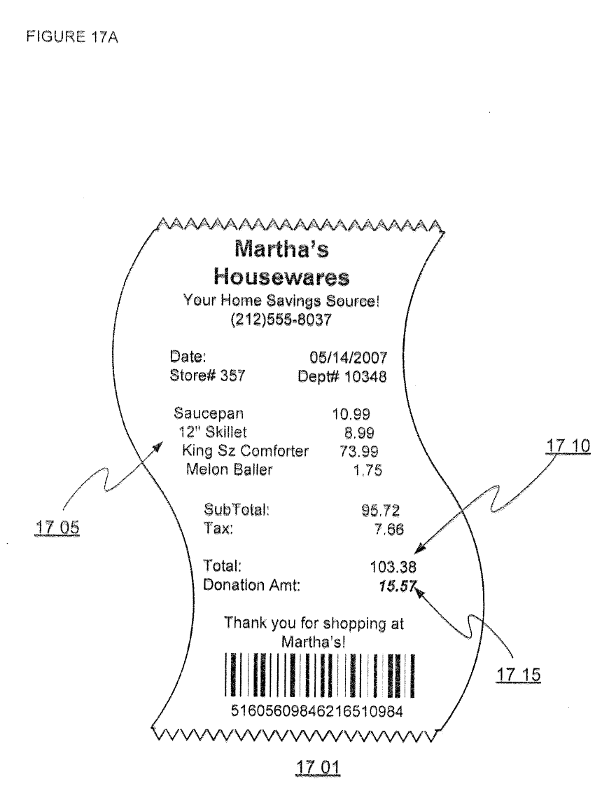

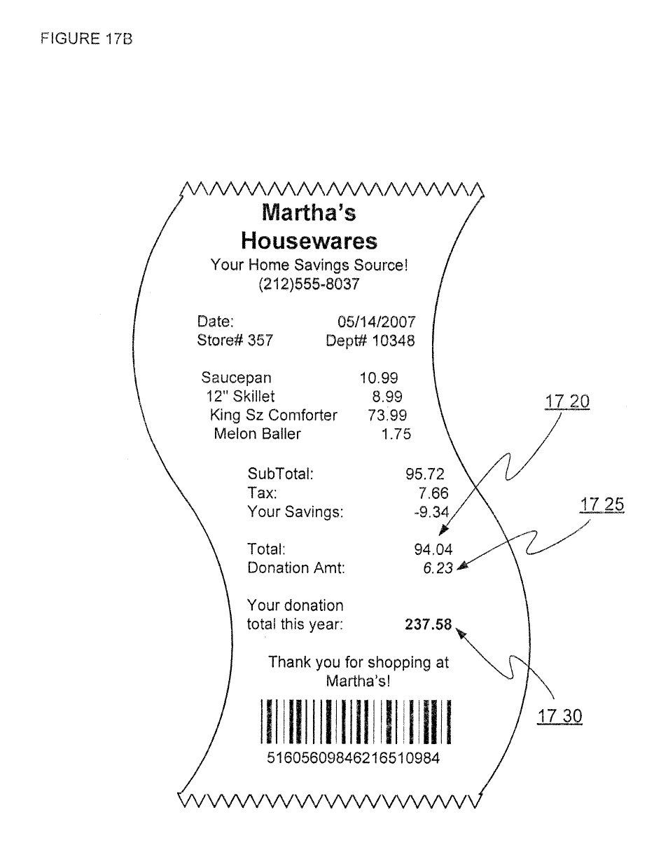

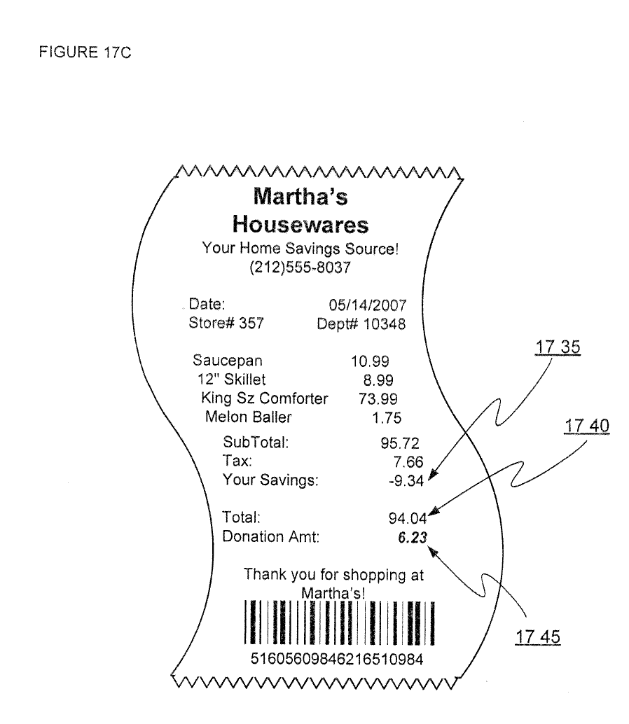

FIGS. 17A-C show customer purchase receipts for on-network purchases indicating Platform coordinated donation amounts in alternative embodiments of Platform operation. FIG. 17A shows a purchase receipt 1701 in one implementation that accompanies the purchase of a selection of housewares, which are listed on the receipt at 1705. In this implementation, a user pays the total purchase price of the purchased goods to the retailer (e.g., Martha's Housewares), and the retailer agrees to donate a portion of the total to the customer's charity of choice. Consequently, the receipt indicates the total purchase price at 1710, as well as the portion of that price that is being allocated for the customer's charity 1715. FIG. 17B shows a purchase receipt that, in addition to indicating the total purchase price 1720 and donation allocation 1725, also shows the total donation amount during the current year that is associated with the customer. The total donation amount may solely reflect those donations made on the customer's behalf by Platform entities based on customer purchases and/or may include personal donations made directly to the charity by the customer. FIG. 17C shows yet another implementation of a purchase receipt within an embodiment of Platform operation in which a customer, brand, payment brand, and/or the like may opt to return a portion of the purchase price to the customer and allocate the remainder to the charity rather than automatically allocating the entire amount to the charity. In this receipt, a personal savings amount (e.g., an instant rebate) is indicated at 1735, followed by an effective total purchase price (i.e., the overall total purchase price less the personal savings amount) 1740, and the resulting donation amount 1745. In various other implementations, a customer's purchase receipt within Platform operation may indicate a variety of other information, such as detailed fund allocation across different selected charities; personal donation history; brand, payment brand, and/or matching agency donation histories; special offers, discounts, and/or the like; and/or the like.

### Matching Funds

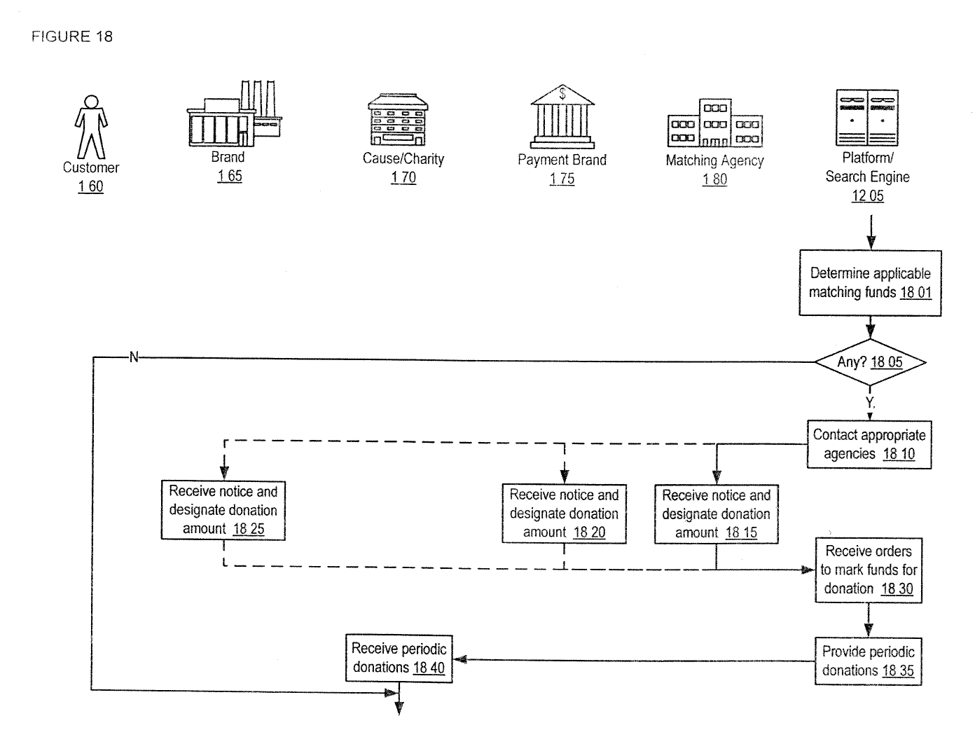

FIG. 18 shows an implementation of matching fund acquisition in an alternative embodiment of Platform operation. When an offer has been successfully fulfilled and a sum of money allocated for donation, the Platform may determine what, if any, matching funds are applicable 1801. In one implementation, Platform participants may specify within their profiles the conditions under which they agree to match donations made by other Platform participants, and subsequent Platform determinations of applicable matching funds may be made by querying these matching conditions. For example, a Platform participant may specify that it will provide a matching donation, up to a pre-specified maximum amount, for any donation made to a particular charity. Subsequent donations to that charity will trigger the solicitation of matching funds by the Platform from that participant. The Platform determines whether any applicable funds exist 1805 and, if so, contacts the appropriate agencies and/or Platform participants at 1810, each of which receives notice and designates and/or confirms designation of a donation amount (1815, 1820, 1825). The Platform subsequently receives participant orders to mark the appropriate matching funds for donation 1830 and provides periodic donations 1835 to be received by the customer's cause and/or charity of choice 1840.

### Donation Flow and Facilitation

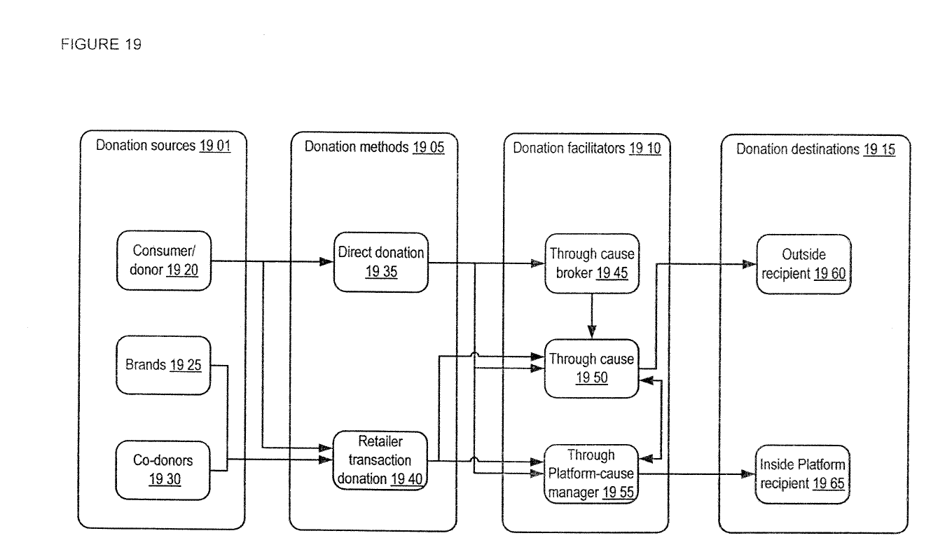

FIG. 19 shows an implementation of donation flow and facilitation in one embodiment of Platform operation, showcasing interactions between donation sources 1901, donation methods 1905, donation facilitators 1910, and donation destinations 1915. A consumer/donor 1920 may supply direct donations 1935 without accompanying retail transactions, or may forgo personal savings within a retail transaction 1940. For example, a consumer/donor may employ Platform features and/or interface elements to directly donate a sum of money to one or more causes. In one implementation, consumer/donor direct donations made using a payment facilitation method (e.g., a credit card) corresponding to a preferred payment brand and/or the payment brand Platform participant may have transaction fees waived by the payment brand. Brands 1925 and co-donors 1930 may also make donations in conjunction with the retail transactions 1940 of consumer/donors 1920. Direct donations may be directed to donation recipients in a number of different ways. In one implementation, funds from direct donations are first passed to an intermediary cause broker 1945 (e.g., the United Way), who subsequently passes them along to a cause 1950. In another implementation, the funds may be passed directly to the cause 1950 or handled via Platform cause manager functionalities 1955. Offer-donation funds associated with retail transactions 1940 may be passed either directly to the cause 1950 or handled via Platform cause manager functionalities 1955. Donations that are received by the cause may be distributed to outside recipients 1960 via existing external channels. Alternatively, a cause that manages donations may elect to manage and/or distribute them through Platform cause manager functionalities, which is configurable to distribute funds to Platform participants designated as fund recipients 1965. The Platform cause manager functionalities may also be configured to pass funds to a cause for direct distribution to outside recipients 1960.

In one embodiment, the Platform and/or Platform participants may employ certified accounting records and/or contractual agreements in order to track consumer purchases, donation obligations, and/or the like and to ensure that committed funds are duly distributed. For example, in one implementation, a retail brand may create funds that are bonded, certified, pre-paid, guaranteed, insured, and/or the like with one or more payment facilitation agencies or services from which donations may be drawn as directed by Platform accounting records. In another implementation, online payment facilitation services and/or accounts (e.g., Google Checkout, PayPal, and/or the like) may be employed in conjunction with the Platform to track purchases and donations, maintain accounting records, and/or the like. In another implementation, a retail and/or manufacturer brand Platform participant may establish a contractual relationship with one or more payment brand Platform participants, whereby payments made to the retail and/or manufacturer brand by a consumer/donor using a payment brand payment facilitation method (e.g., a credit card) may be automatically parsed into sales revenue and donation components and distributed accordingly. The payment brand would report all payment and donation distributions to the Platform for accounting and reporting purposes.

In one implementation wherein a number of payment brands and/or payment processing agencies may employ a common Interactive Transaction Data System, the Platform may interact with that system to track consumer/donor purchases, generate reports, transfer consumer/donor information, and/or the like. The Interactive Transaction Data System, in such an implementation, acts as a virtual data “backbone” carrying consumer/donor purchasing information that may be tapped into by the Platform for tracking and/or reporting purposes. In particular, consumer/donors making purchases via payment facilitation methods connected to an Interactive Transaction Data System may freely purchase products at off-network retailers and still have those purchases register with the Platform in order to fulfill the terms of accepted offer-donations.

In one implementation, returns or refunds for cash on products and/or services that were part of an offer-donation may cancel an entire offer-donation (i.e., the donations to the consumer/donor's cause of choice may not be made). If the donations have already gone through, the consumer/donor may not be permitted to receive a cash refund, but may still be provided with retail credits, exchanges, and/or the like. Similarly, a consumer/donor may, in some implementations, opt for retail credits and/or exchanges prior to a donation being made to his or her cause of choice if he or she wishes that donation to proceed. In one implementation, a brand may be willing to waive the restriction on cash refunds in limited circumstances and still provide donations to consumer/donors' causes of choice in order to promote further brand loyalty.

In one implementation, in the event that a transaction/donation is reversed for whatever reason, the consumer/donor may receive the option of a new offer-donation from the brand(s) to participate in the same or similar offer-donations in the future. The new offer-donation may be tailored to take the specific details into consideration that resulted in the reversal of the first offer-donation so that any perceived damage in the relationship between the consumer/donor and the brands can quickly be repaired should that be viewed as an issue by the brand(s). For example, a new offer-donation may be made by a retail brand to provide a significant discount on the consumer/donor's next purchase, or the same brand(s) could follow the reversal with another offer-donation where an even greater “one-time” donation might be made under the same terms and conditions.

### Search and Sort

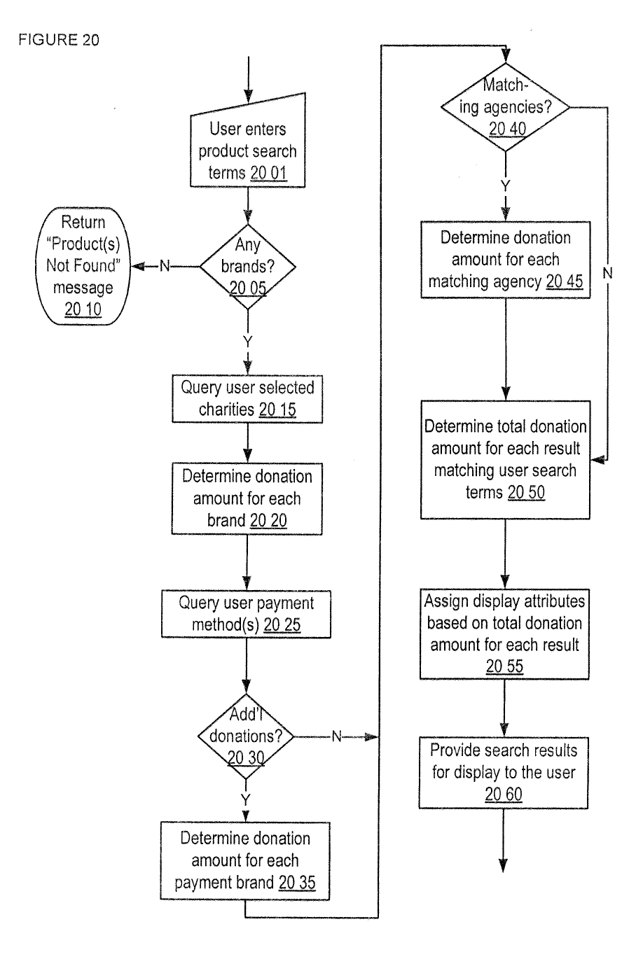

FIG. 20 shows an implementation of search functionality in one embodiment of Platform operation. At 2001, a Platform user enters search terms corresponding to a desired product, service, offer, and/or the like. A determination is first made as to whether there exist any brands with products or offers matching the entered search terms 2005. If not, then a message is returned to the user indicating that no results were returned for the entered search terms 2010. If, on the other hand, there are existing brands with products, services, offers, and/or the like matching the user entered search terms, then the Platform may query user selected causes and/or charities registered in the user's profile at 2015. At 2020, the Platform determines the amount that each brand, having products matching the user's search terms, is willing to donate to the user's selected causes and/or charities.

At 2025, the Platform may query a user payment method or methods. In one implementation, the Platform may retrieve a user's preferred payment method from the user profile, while in another implementation the Platform may directly query the user for the likely payment method. At 2030, the Platform determines whether additional donations are available based on the user-specified payment method. For example, a Platform participating payment brand may agree to match donations for all purchases made with a particular credit card. If additional donations are in order, then the Platform determines the expected amount of those donations at 2035 for the relevant payment brand or agencies. In one implementation, a user may be allowed to specify multiple candidate payment methods in order to ultimately see which payment method would provide the greatest advantage to him or her and/or to his or her cause of choice.

At 2040, the Platform determines whether there are any matching agencies that might donate to the user's selected cause as well. If so, the Platform determines the donation amount that each matching agency is willing to provide for each brand, payment method, and/or the like resulting from the user's search 2045. This determination may be made, for example, by querying each matching agency's profile information to extract the conditions that the agency's matching funds are subject to (e.g., restricted to particular retail brands, manufacturer brands, charities, or payment brands; limited by maximum or minimum donation amounts; etc.), and comparing those conditions with the circumstances associated with each search result. For example, a particular matching agency may specify in its profile that it is willing to fully match donations, up to a pre-specified maximum, that are made to a user's charity of choice for purchases made from Brand A. Thus, the Platform will determine a total donation amount incorporating that matching agency's funds for any search results associated with Brand A, but will exclude the matching agency's contribution for results associated with other brands.

At 2050, the Platform may determine the total donation amount for search results corresponding to each brand, payment method, payment brand, and/or the like. The total donation amount may be calculated as the sum of the donation amounts provided by the brand, the payment brand, the matching agencies, and/or any other contributing Platform participant. Once total expected donation amounts are determined, the Platform may assign display attributes to the search results based on the donation amounts 2055. For example, in one implementation, the Platform may assign a ranking to each search result based on the donation amount and generate a ranked list. In another implementation, the Platform may assign a display size, color, highlight degree, state of animation, and/or the like to the search results based on the donation amount, Finally, at 2060, the search results, configured with their corresponding display attributes, may be presented for display to the user.

In alternative embodiments, the Platform may be configured to assign display attributes to search results based upon the ratio of the total expected donation amount to the total product price (e.g., the percentage of the price allocated for donation), the total product price itself, the number of matching funds, and/or the like.

Management responsibilities for aspects of the search functionalities described above may be distributed between the Platform and a partnering search engine as deemed appropriate within various embodiments of Platform operation. For example, in one embodiment, a search engine may perform the initial determination of whether there exist any results matching the user entered search terms (e.g., 2005 in FIG. 20), and then pass these results to Platform modules, which may subsequently determine the appropriate display attributes that highlight those results which maximize donations to the customer's causes and/or charities of choice. Once the display attributes have been established, the Platform modules may pass the results back to the search engine for display to the customer.

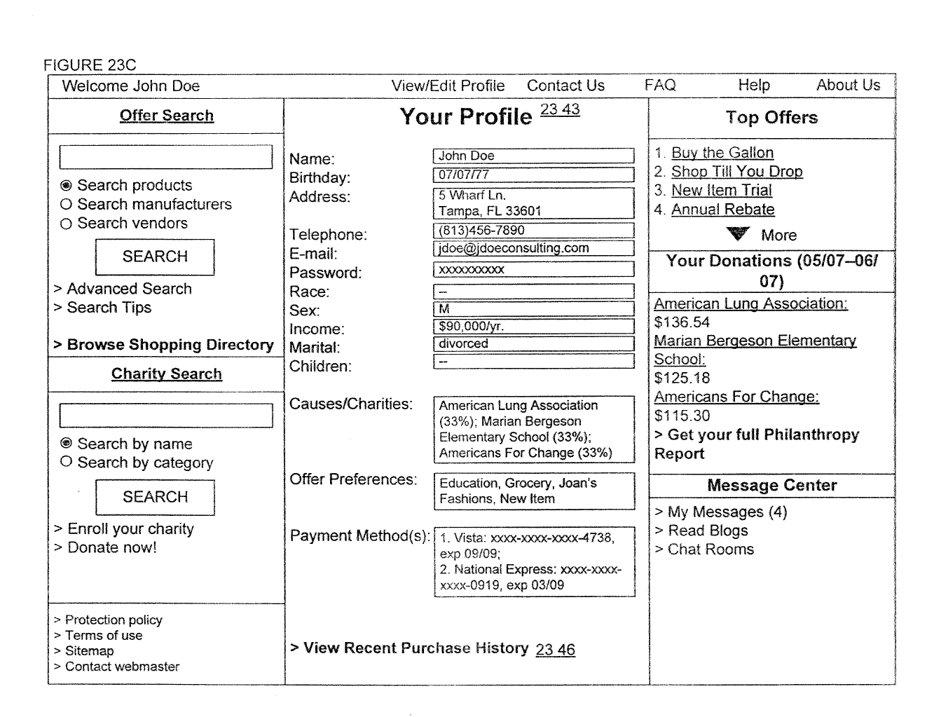

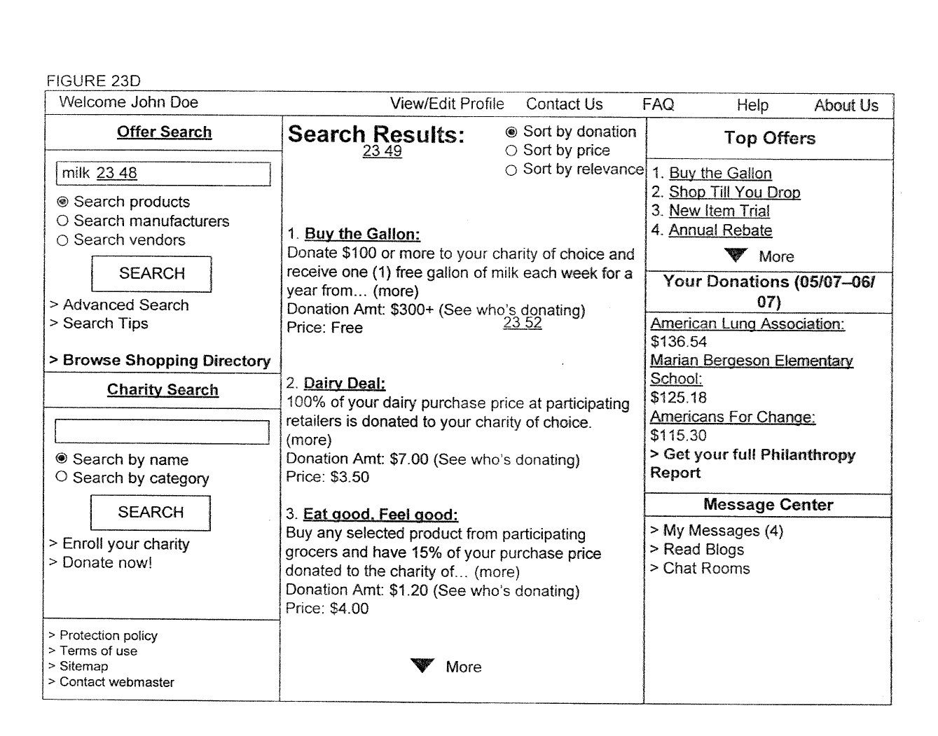

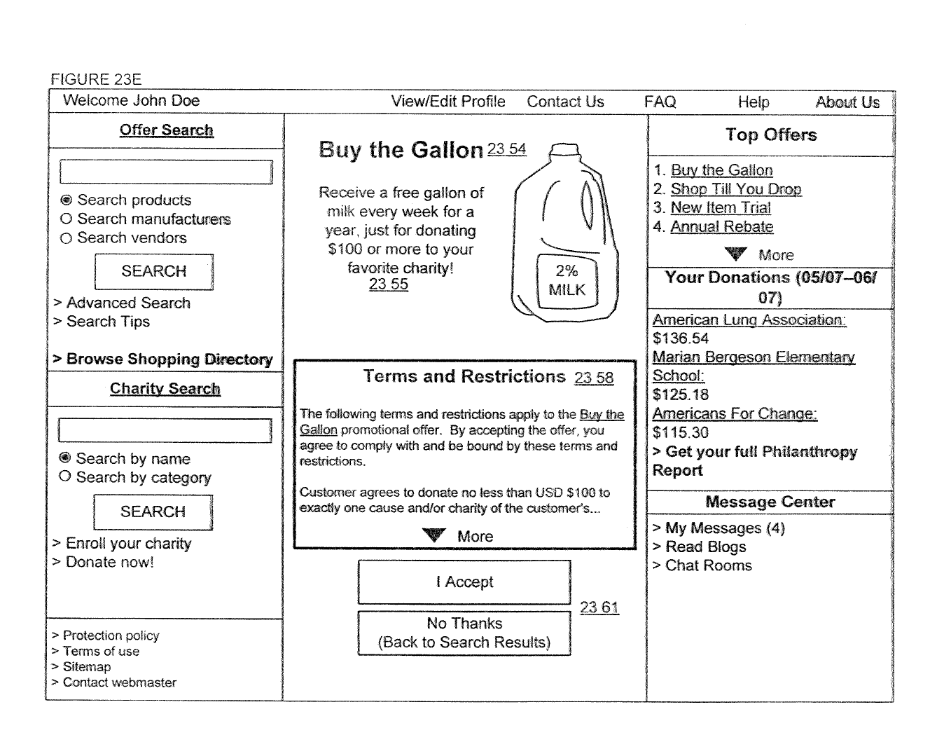

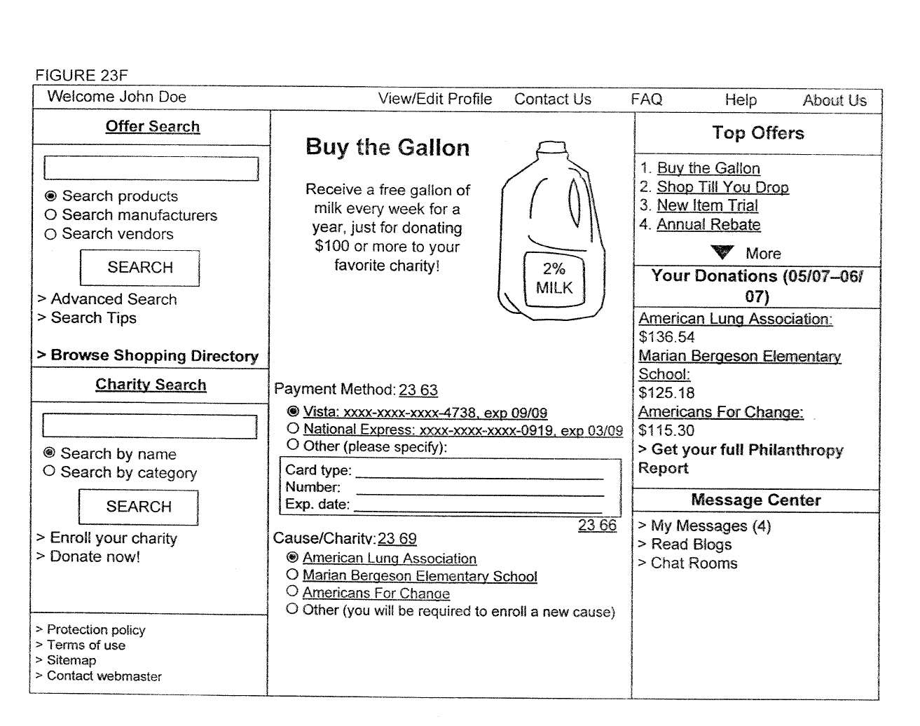

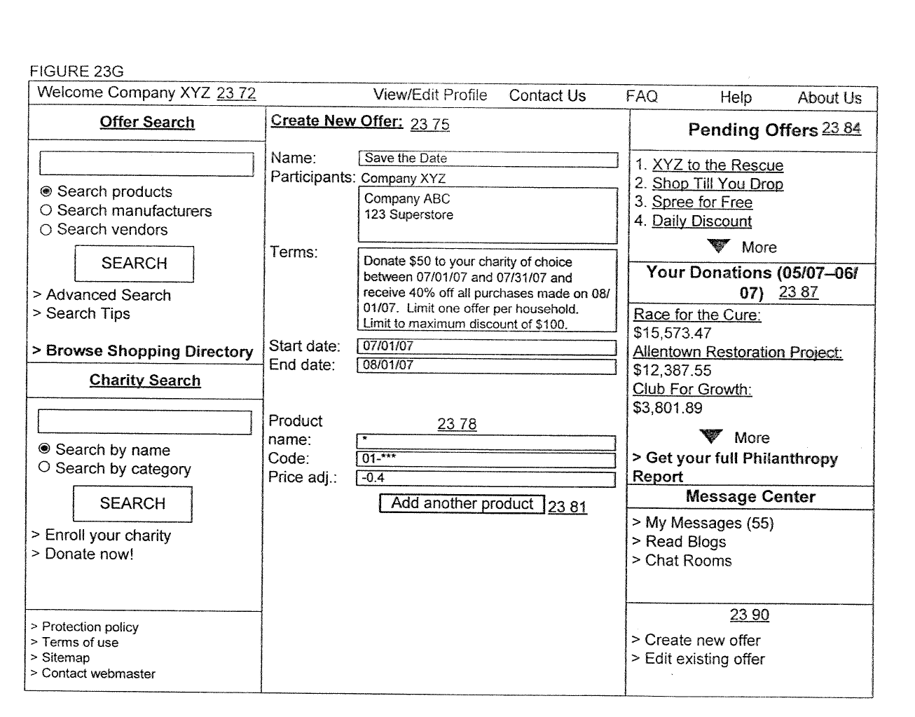

In one embodiment, the Platform's search functionality may be provided directly via a Platform website and/or other Platform administered user interface (see, e.g., FIG. 23D). In an alternative embodiment, Platform functionality may be provided to a partnering search engine, whereby users may elect to have display attributes of search results acquired via that search engine altered based on expected donation amounts using Platform functionality. For example, a partnering search engine may have an interface element (e.g., a button widget) that causes product search results to be sorted based on the size of the expected donation amount associated with purchase of each displayed product. The partnering search engine may also be provided with access to Platform offers for display in response to a product search.

In one embodiment, Platform participants who generate offers may be provided with codes that may be incorporated into offer advertisements and/or other offer promoting web pages that are detectable by the partnering search engine and would, thus, show up in response to users searching for offers. A wide variety of such codes may be employed within various embodiments and implementations of Platform operation, and may include numerical codes, text codes, images, bar codes, 2D matrix codes, and/or the like. The search engine's web indexing tools may be configured to detect these embedded codes and recognize the corresponding web pages as valid and/or approved Platform offers. In addition to producing these offer pages in response to a search for offers, the search engine may also preferentially produce these pages when a user searches for a product and/or service for which corresponding Platform offers have been indexed.

### Advertising

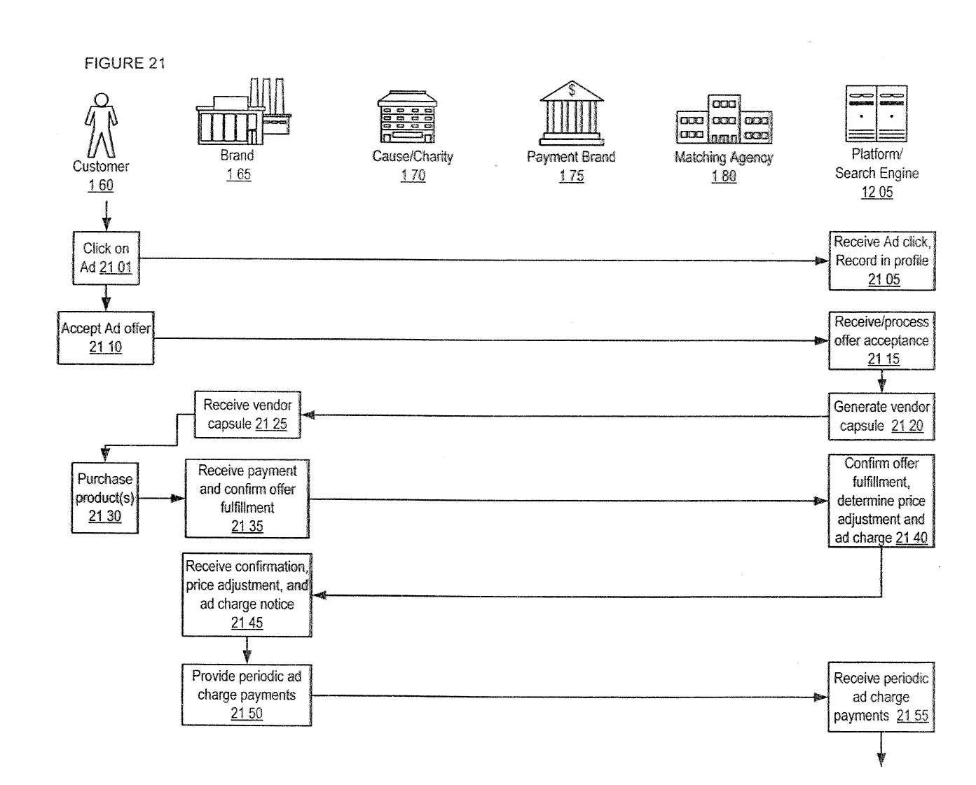

The Platform provides a framework for a novel pay-per-action advertising scheme that connects online and offline shopping experiences. FIG. 21 shows an implementation of pay-per-action advertising in one embodiment of Platform operation. At 2101, a customer clicks on an online advertisement for a Platform-associated offer. Such advertisements may be served on a dedicated Platform website, brand website, cause and/or charity website, and/or anywhere else where advertising space is available. The Platform may record the ad click and associate it with a customer profile if the customer is registered and can be identified 2105, such as by finding a cookie on the customer computer. The customer who has clicked on the ad may subsequently decide to accept the offer associated with the Ad 2110, and the Platform receives and processes that offer acceptance at 2115. The Platform generates a brand capsule corresponding to the accepted offer at 2120, which is received by the brand at 2125.

When the customer purchases the product associated with the offer 2130, the brand receives the customer's payment and submits an offer fulfillment confirmation request to the Platform 2135. The Platform, in turn, receives the offer fulfillment confirmation request and, if appropriate, provides confirmation, determines the appropriate price adjustment, and also determines an appropriate ad charge 2140 to be paid by the brand who originated the ad that the user clicked on in 2101. The amount of the ad charge may be freely determined by Platform administrators. In one implementation, the ad charge may be tied to the revenue generated for the brand by the customer purchase and/or offer acceptance. The brand receives the offer fulfillment confirmation, price adjustment, and ad charge notice at 2145 and provides payment to the Platform 2150, who receives the payment at 2155. In one implementation, the ad charge payments are made periodically in time, while in another implementation the ad charge payments are made whenever their amount exceeds a pre-specified minimum.

In an alternative implementation, a pay-per-action scheme may exist without the use of a brand capsule. A consumer may register interest in a product and/or offer-donation, such as by clicking on a product and/or offer-donation advertisement on a Platform website. The Platform may subsequently track the purchase of the product and/or fulfillment of the offer-donation (e.g., via an intelligent cash-register at an on-network retail brand location, via a credit card record from a payment brand Platform participant payment facilitation method, and/or the like) and charge the brand corresponding to the product and/or offer-donation for the advertisement based on the consummation of the transaction.

### Voluntary/Direct Donation

In some embodiments, the Platform may be configured to relay voluntary and/or direct donations from Platform participants to one or more causes and/or charities. These voluntary donations may take a variety of forms within different implementations and applications of Platform functionality. Some examples of voluntary donations facilitated by the Platform may include:
a one-time monetary contribution.
a periodic and/or scheduled monetary contribution.
a self-imposed “donation sales tax”, whereby a customer voluntarily pays an extra premium on top of the price of all items purchased with a particular credit card.
an allocation of all sales, discounts, rebates, and/or the like from a particular brand to a customer's causes and/or charities of choice.

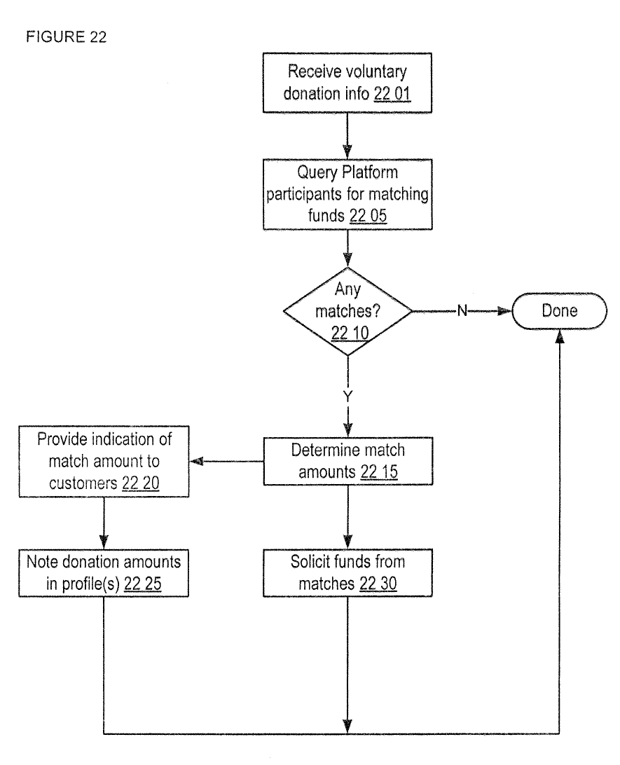

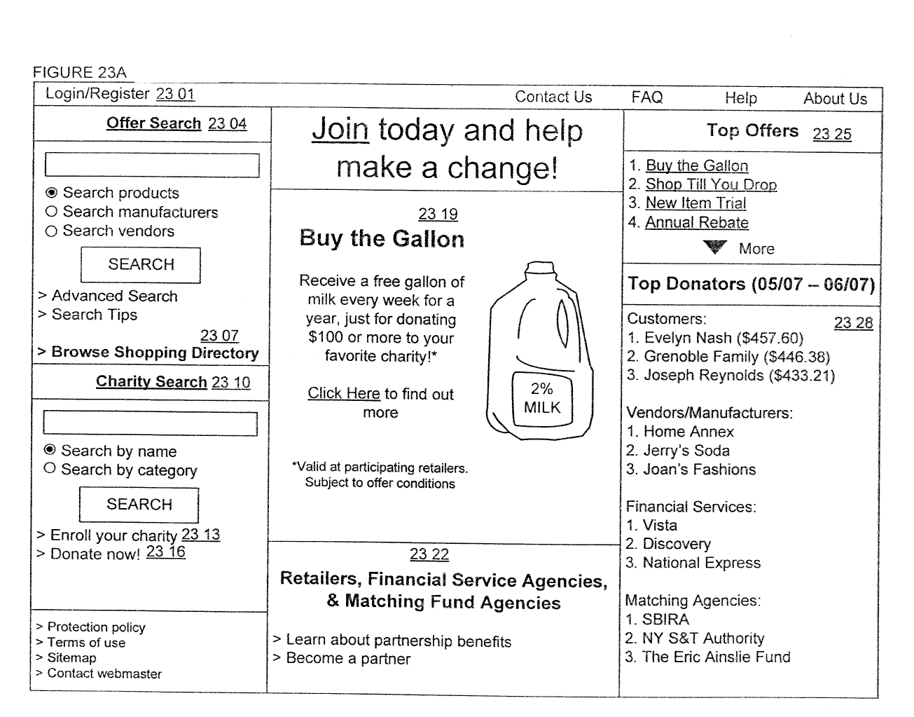

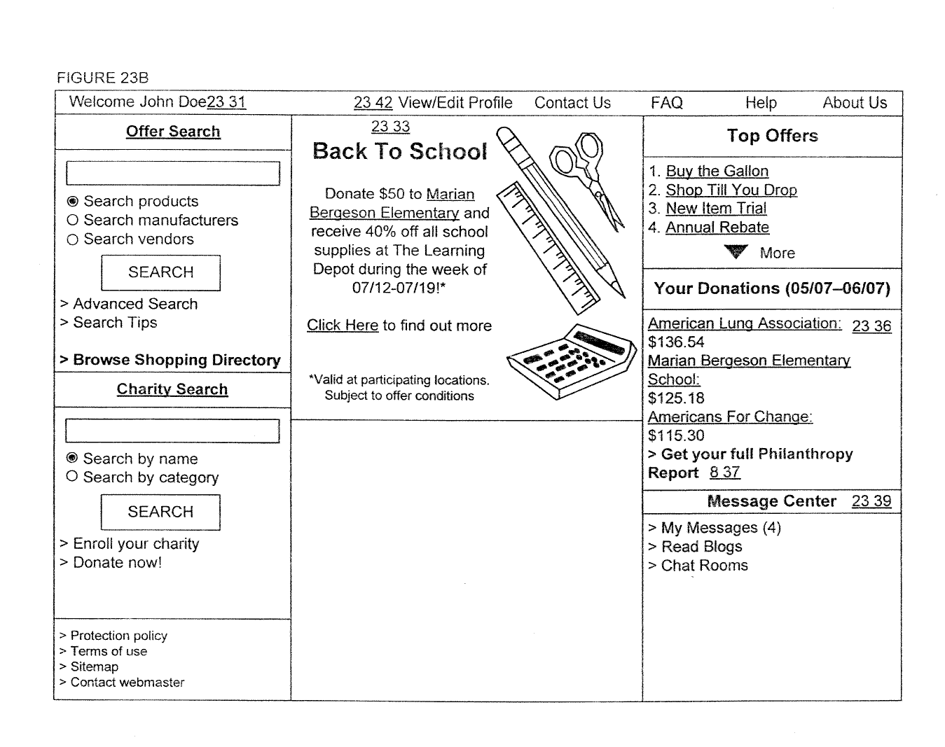

FIG. 22 shows an implementation of logic flow for voluntary and/or direct donation processing in one embodiment of Platform operation. At 2201, the Platform receives an indication of a voluntary donation. This may comprise, for example, a customer interaction with a donation module within a Platform-enabled website. Another example may be a customer purchasing an item with a credit card for which he or she has designated a self-imposed donation sales tax of the form described above. When an indication of such a voluntary donation has been received, the Platform may query other Platform participants and/or participant profiles to determine if there exist any funds to match the voluntary donation 2205. That determination may be made, for example, by comparing a set of donation circumstances with tags, keywords, rules, and/or the like associated with a matching fund and/or Platform participant. A determination is made at 2210 whether any matching funds exist and, if not, then no further inquiry into matching funds is made for the current donation. If there are available matching funds, however, the Platform determines the amount of those matching funds at 2215. This determination may be made, for example, by comparing the circumstances of the donation, including the amount, with the rules and/or conditions of the matching fund. An indication of the amount of the matching funds may be provided to the donator and/or provider of the matching fund at 2220, and the donation amount (e.g., the voluntary donation amount, the matching fund amount, etc.) may be noted in the profiles of the Platform participants involved in the donation 2225. The matching funds from matching Platform participants are solicited at 2230. In an alternative implementation, the matching funds are automatically withdrawn from a Platform participant's account.

In another implementation, the Platform may provide an interface to allow users to search for matching funds for a hypothetical donation prior to actually making the donation. The users may be requested to submit information describing the circumstances of the donation, such as the amount of the donation, a proposed donation date, the causes and/or charities to which the donation is directed, and/or the like. Based on these circumstances, the Platform may search Platform participant profiles for matching funds and present the results to the user.

### Platform User Interface

FIGS. 23A-G showcase illustrations of alternative implementations of user interfaces for particular aspects of Platform functionality within alternative embodiments of Platform operation. FIG. 23A shows an exemplary illustration of an initial Platform interface (e.g., web page) that a user might encounter prior to registering and/or logging in. Thus, at 2301 is provided a link facilitating login and/or registration of new users. In addition, this initial interface provides an offer search window, allowing users to search offers based on a variety of search criteria 2304. A simple search may allow users to search based on products, brands, while an advanced search option may admit a variety of other search criteria, including such possibilities as tags and/or keywords, offer dates, donation amounts, endorsing participants (e.g., an offer may be endorsed by a particular cause and/or charity), terms, conditions, restrictions, price adjustments, and/or the like. The user is also provided with a shopping directory link 2307, which may provide access to a structured listing of offers, products, retail brands, manufacturer brands, and/or the like that is amenable to browsing. In addition to the offer search, the interface in FIG. 23A provides a charity search feature 2310, whereby users may search for registered charities, causes, and/or the like by name or category. Links are also provided to allow a user to register a new cause or charity with the Platform, and to directly make a donation to a registered cause or charity 2316.

The interface of FIG. 23A further includes an offer advertisement 2319. Since the user has not yet logged in, the advertisement provided on this initial page may not be targeted to the particular user but may, rather, be selected randomly, selected based on offer popularity, and/or based on some other non-user specific criteria. At 2322, links are provided to allow particular institutional Platform users (e.g., retail brands, manufacturer brands, payment brands, matching fund agencies, and/or the like) to learn more about the Platform and/or to register for Platform partnership and/or participation. At 2325, a list of links to top offers is provided, showcasing those offers that are most popular with customers. At 2328, a list of top donators for the period of May-June 2006 is provided, displaying those customers, retail brands, manufacturer brands, payment brands, and matching fund agencies that have provided the largest donations to various causes and charities over the specified period.

FIG. 23B exhibits an exemplary user interface displayable to a customer who has logged in, as indicated by the welcome message at 2331. Here, an advertisement that is specifically targeted to the user is provided at 2333, based on the customer's selected causes and/or charities, profile information, offer preferences, transaction history, and/or the like. The customer's selected causes and/or charities are displayed at 2336, along with data pertaining to the total donation amounts provided to each cause and/or charity as a result of the customer's actions and/or product purchases. A link is also provided in this window allowing the customer to view his or her “philanthropy report” 2337, which may detail stored data regarding donations, allocations, purchases, offers, transactions, and/or the like that the customer has participated in and/or is responsible for, along with any statistics, charts, graphs, tables, and/or analyses thereof. Finally, a message center 2339 is provided to facilitate communication with other Platform users and participants. The message center in the illustrated implementation includes links to: personal messages; Platform blogs, journals, diaries, and/or the like; and live and/or real time chat room features.

Selection of the link at 2342 to view/edit the user profile may lead to the exemplary interface shown in FIG. 23C. Here, an editable customer profile is displayed at 2343, and includes a number of fields that characterize the customer and his or her Platform preferences. For example, these fields may include name and/or username, birthday, address, telephone number, email address, password, race, sex, income, marital status, number of children, selected causes and/or charities (as well as donation allocations among them), offer preferences (e.g., tags and/or keywords describing offers that the customer is interested in receiving notifications about), payment methods, and/or the like. A link is also provided in this example to allow the customer to view his or her recent purchase and/or transaction history 2346.

In an alternative implementation, users may register with the Platform indirectly via other Platform participants. For example, causes and/or charities may encourage sympathetic individuals to enroll with the Platform by providing registration materials as hard copy forms, online forms, and/or the like. Similarly, brands may encourage customers to enroll with the Platform by providing registration materials to customers at the POS (e.g., a registration form in a brochure), on the brand website, and/or the like.

FIG. 23D shows an exemplary illustration of a user interface displaying search results in response to a user's offer search query. In this case, the search query entered by the user is “milk” 2348, and the resulting offers are displayed at 2349. In this example, the offers may be sorted based on offer characteristics such as donation amount, price, or search term relevance. In alternative implementations, other search result display attributes besides listing order may be adjusted based on offer characteristics, such as display size, color, highlighting, state of animation, absolute or relative screen position, and/or the like. Each of the displayed offers includes a link to display the brands participating in the offer 2352.

FIG. 23E shows an exemplary illustration of a user interface displaying information related to a specific offer, including an offer title 2354, an offer description 2355, offer terms and restrictions 2358 (which may be distinct from the description in that the terms and restrictions detail the specific regulations governing acceptance and fulfillment of the offer), and buttons with which the customer may accept or decline the offer 2361.

FIG. 23F shows an exemplary illustration of a user interface displaying an accepted offer. Here, the customer is requested to select a payment method 2363. This may be chosen from existing payment methods specified in the user profile, or the user may supply a new payment method 2366, which the Platform may check for validity prior to registering the customer's offer acceptance. The customer is further requested to select one or more causes and/or charities to receive donations through the offer 2369. These may be causes and/or charities specified in the customer profile, or the customer may elect to enter a new cause and/or charity. In the present example, the offer only admits donation to a single cause and/or charity (see the offer terms 2358 in FIG. 23E), however in alternative implementations, a customer may specify multiple donation recipients, and/or designate specific donation allocations for each of the multiple recipients.

FIG. 23G shows an exemplary illustration of a user interface displaying an offer generation form presented to a brand who has logged in, as indicated by the welcome message at 2372. The central window showcases the offer generation form 2375, which includes a number of fields through which the brand may define the offer, including a name, participant list (e.g., retail brands, manufacturer brands, and/or the like who have agreed to honor the offer), offer terms, start date, end date, and/or the like. The offer further includes fields to specify products for which the offer applies 2378. These fields include product names, codes, and associated price adjustments. In the present example, asterisks have been included in the product fields to reflect the fact that the offer applies to all products for the specified time period. A button has also been included to allow the brand to include additional products within the scope of the offer 2381. Within this brand page are also provided windows displaying a list of pending offers 2384, a list of donations 2387, and links to create and/or edit offers 2390.

### Various Applications

The Platform provides an efficient and effective means for connecting, directing, and coordinating purchases and donations that may be applied to a wide variety of promotional, marketing, advertising, and other commercial applications. In one embodiment, the Platform may be employed as a marketing and/or promotional tool. Participating brands may register with the Platform in order to be provided access to registered Platform users and to present them with product promotions that include a donation to the causes and/or charities chosen by those users. By allowing users to choose their own favorite causes and/or charities to receive donations, the Platform provides more effective incentives for customers to participate in offers and purchase products from participating brands. Furthermore, by drawing in additional funds from retail brands, manufacturer brands, payment brands, matching fund agencies, and/or the like to match and coordinate with customer-initiated donations, the Platform maximizes the total donation amounts provided to customer selected causes and/or charities, thereby fully incentivizing customers to consider Platform-associated products and increasing the likelihood of consummated transactions.

In another embodiment, the Platform may provide a novel means for tracking customer behavior and providing targeted advertising. Because so many customer actions (e.g., offer searching, advertising clicking, offer acceptance, transactions, etc.) are registered with Platform modules, the Platform possesses a detailed knowledge of customer behavior and preferences that may be analyzed in order to provide offer notices and other advertising to the customers that are specifically targeted to them. In addition, the Platform's knowledge of customer information through the customer profile (e.g., location, demographics, causes and/or charities selected by the customer to receive donations by the customer, etc.) allows it to further refine targeting of ads and offers. In one implementation, tags or keywords may be associated with a user profile based on profile contents and user behavior. Those tags may then be compared with tags associated with ads and/or offers to find matches, and those ads and/or offers containing the highest number of matching tags and/or keywords may be preferentially selected for provision to the customer.

In another embodiment, the Platform provides an agency for facilitating a novel pay-per-action advertising model. When customers click on Platform advertisements promoting offers, the Platform may register that activity and track further customer behavior with respect to that action. Acceptance of the associated offer by the customer and eventual consummation of the transaction (e.g., fulfillment of the offer terms) are all trackable by the Platform, allowing the Platform to charge a fee for the advertisement based on the actual transaction consummation rather than simply the initial impression, click, and/or the like. This provides potential advertisers with a clear connection between advertising efficacy and expenditure that is highly valuable.

In another embodiment, the Platform may be employed as a fundraising tool. Causes and/or charities participating in the Platform system may encourage sympathetic customers to select them to receive donations and/or direct customers to particular ads or offers which may result in larger donations being provided to them. For example, a church seeking donations may encourage its parishioners to designate it as the recipient of Platform-associated donations and to make as many of their grocery purchases as possible through Platform offers for one month. The Platform may also increase donations to a given cause and/or charity by coordinating matching funds for any direct donations made by Platform participants. For example, a parishioner who elects to make a direct donation of $100 to his church may trigger an additional $50 in matching funds from other Platform participants who have agreed to donate that amount under the conditions of the parishioner's initial donation. A donation made outside of the Platform would not trigger such potential matching donations, so causes and/or charities have an incentive to encourage potential donators to make donations through the Platform.

In another embodiment, the Platform provides a means for groups to pool funds. Through communication functionalities provided by the Platform, such as chat, messaging, blogs, and/or the like, as well as through real-life participation in causes, charities, volunteer activities, church or school activities, and/or the like, Platform participants may coordinate with one another to achieve common donation goals that would exceed the donation capabilities of any one user. For example, a group of customers may collectively agree to direct all donations originating from clothing purchase-related offers to Clothe the Homeless.

In another embodiment, the Platform may be employed within a gifting application. A group of customers may collectively agree to direct all proceeds from offer fulfilling purchases to a gifting fund intended for use in the purchase of an expensive gift that no one customer could individually afford. For example, a collection of employees may pool their Platform donations, directing them to a fund that is to be used for purchasing a retirement gift for their boss.

In another embodiment, the Platform may be configured to provide personal discounts and/or savings. Brands may return a portion of the purchase price of various products to the customers themselves for fulfilled offers. In contrast with existing systems for sales, discounts, rebates, and/or the like, however, such Platform-enabled personal discounts are fully trackable and may operate within the context of the aforementioned pay-per-action advertising model. Furthermore, in one implementation, customers may search and/or have search result display attributes configured based on expected discount amounts. For example, the Platform may allow a customer to search for a product and receive search results that are sorted based on the amount of discount that a particular store, sale, promotion, and/or the like provides. In one implementation, personal discounts are provided as an instant rebate, while in another implementation, personal discounts are provided some time after a purchase, such as via periodic rebate checks sent to the customer. In yet another implementation, personal discounts may be directed to a personal discount fund that may be allocated, for example, for bill paying.

In another embodiment, the Platform facilitates the creation of partnerships between various Platform participants. For example, various brands may partner within the context of a given offer, and therein undergo a collective promotional and/or marketing campaign that is mutually beneficial for all participants. Similarly, one or more brands may partner with one or more causes and/or charities to promote an offer that both promotes the brands' products and promises donations for the causes and/or charities. In one implementation, the Platform may provide mechanisms, including online forms and communication tools, to facilitate the coordination of partnerships and agreements that may, in some implementations, be legally binding for participating counterparties.

### Platform Controller

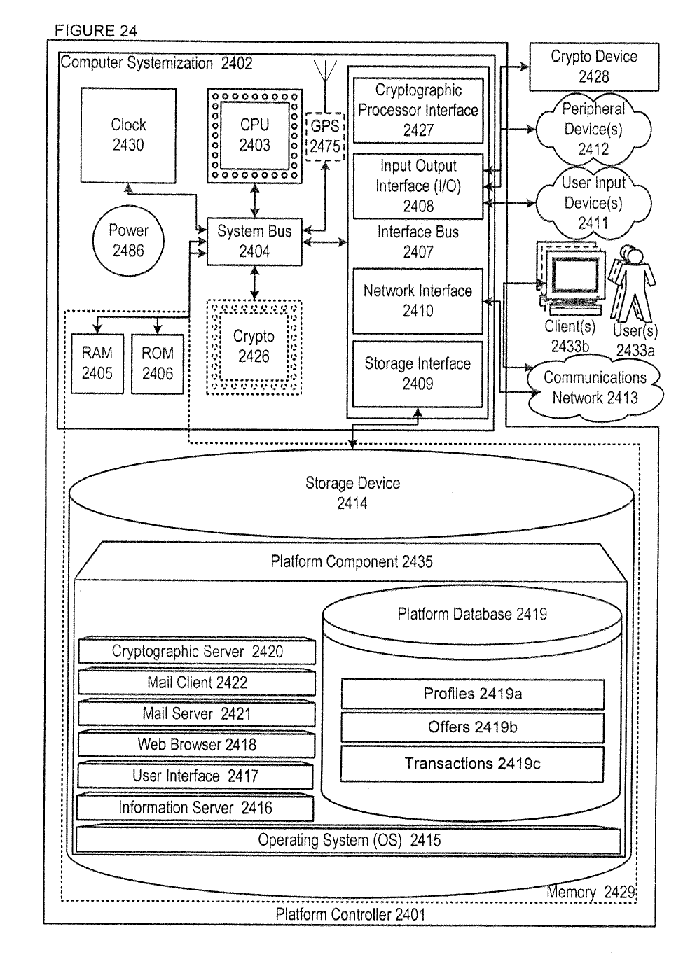

FIG. 24 of the present disclosure illustrates inventive aspects of a Platform controller 2401 in a block diagram. In this embodiment, the Platform controller 2401 may serve to aggregate, process, store, search, serve, identify, instruct, generate, match, and/or update databases, database elements, database element fields, and/or other related data.

Typically, users, which may be people and/or other systems, engage information technology systems (e.g., commonly computers) to facilitate information processing. In turn, computers employ processors to process information; such processors are often referred to as central processing units (CPUs). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Platform controller 2401 may be connected to and/or communicate with entities such as, but not limited to: one or more users from user input devices 2411; peripheral devices 2412; a cryptographic processor device 2428; and/or a communications network 2413.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Platform controller 2401 may be based on common computer systems that may comprise, but are not limited to, components such as: a computer systemization 2402 connected to memory 2429.

Computer Systemization

A computer systemization 2402 may comprise a clock 2430, central processing unit (CPU) 2403, a read only memory (ROM) 2406, a random access memory (RAM) 2405, and/or an interface bus 2407, and most frequently, although not necessarily, the foregoing are all interconnected and/or communicating through a system bus 2404. Optionally, the computer systemization may be connected to an internal power source 2486. Optionally, a cryptographic processor 2426 and/or a global positioning system (GPS) component 2475 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Platform controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 2486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2486 is connected to at least one of the interconnected subsequent components of the Platform thereby providing an electric current to all subsequent components. In one example, the power source 2486 is connected to the system bus component 2404. In an alternative embodiment, an outside power source 2486 is provided through a connection across the I/O 2408 interface. For example, a USB and/or IEEE 1394 connection carries both data and power across the connection and is therefore a suitable source of power.

Interface Adapters

Interface bus(es) 2407 may accept, connect, and/or communicate to a number of interface adapters, conventionally although not necessarily in the form of adapter cards, such as but not limited to: input output interfaces (I/O) 2408, storage interfaces 2409, network interfaces 2410, and/or the like. Optionally, cryptographic processor interfaces 2427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2409 may accept, communicate, and/or connect to a number of storage devices such as, but not limited to: storage devices 2414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2410 may accept, communicate, and/or connect to a communications network 2413. Through a communications network 2413, the Platform controller is accessible through remote clients 2433b (e.g., computers with web browsers) by users 2433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2410 may be used to engage with various communications network types 2413. For example, multiple network interfaces may be employed to allow for the communication over broadcast, multicast, and/or unicast networks.

Input Output interfaces (I/O) 2408 may accept, communicate, and/or connect to user input devices 2411, peripheral devices 2412, cryptographic processor devices 2428, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared, joystick; keyboard; midi; optical; PC AT; PS/2; parallel; radio; serial; USB; video interface: BNC, coaxial, composite, digital, Digital Visual Interface (DVI), RCA, RF, antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 2411 may be card readers, dongles, finger print readers, gloves, graphics tablets, joysticks, keyboards, mouse (mice), remote controls, retina readers, trackballs, trackpads, and/or the like.

Peripheral devices 2412 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Platform controller may be embodied as an embedded, dedicated, and/or monitor-less (i.e., headless) device, wherein access would be provided over a network interface connection.

Cryptographic units such as, but not limited to, microcontrollers, processors 2426, interfaces 2427, and/or devices 2428 may be attached, and/or communicate with the Platform controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allow for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 2429. However, memory is a fungible technology and resource, thus, any number of memory embodiments may be employed in lieu of or in concert with one another. It is to be understood that the Platform controller and/or a computer systemization may employ various forms of memory 2429. For example, a computer systemization may be configured wherein the functionality of on-chip CPU memory (e.g., registers), RAM, ROM, and any other storage devices are provided by a paper punch tape or paper punch card mechanism; of course, such an embodiment would result in an extremely slow rate of operation. In a typical configuration, memory 2429 will include ROM 2406, RAM 2405, and a storage device 2414. A storage device 2414 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 2429 may contain a collection of program and/or database components and/or data such as, but not limited to: operating system component(s) 2415 (operating system); information server component(s) 2416 (information server); user interface component(s) 2417 (user interface); Web browser component(s) 2418 (Web browser); database(s) 2419; mail server component(s) 2421; mail client component(s) 2422; cryptographic server component(s) 2420 (cryptographic server); the Platform component(s) 2435; and/or the like (i.e., collectively a component collection). These components may be stored and accessed from the storage devices and/or from storage devices accessible through an interface bus. Although non-conventional program components such as those in the component collection, typically, are stored in a local storage device 2414, they may also be loaded and/or stored in memory such as: peripheral devices, RAM, remote storage facilities through a communications network, ROM, various forms of memory, and/or the like.

Operating System

The operating system component 2415 is an executable program component facilitating the operation of the Platform controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/VistaXP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Platform controller to communicate with other entities through a communications network 2413. Various communication protocols may be used by the Platform controller as a subcarrier transport mechanism for interaction, such as, but not limited to: multicast, TCP/IP, UDP, unicast, and/or the like.

Information Server

An information server component 2416 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Platform controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Platform database 2419, operating systems, other program components, user interfaces, Web browsers, and/or the like.

Access to the Platform database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Platform. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Platform as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 2417 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact with, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 2418 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Platform enabled nodes. The combined application may be nugatory on systems employing standard Web browsers.

Mail Server

A mail server component 2421 is a stored program component that is executed by a CPU 2403. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Platform.

Access to the Platform mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 2422 is a stored program component that is executed by a CPU 2403. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 2420 is a stored program component that is executed by a CPU 2403, cryptographic processor 2426, cryptographic processor interface 2427, cryptographic processor device 2428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Platform may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Platform component to engage in secure transactions if so desired. The cryptographic component facilitates the secure accessing of resources on the Platform and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Platform Database

The Platform database component 2419 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Platform database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Platform database is implemented as a data-structure, the use of the Platform database 2419 may be integrated into another component such as the Platform component 2435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2419 includes several tables 2419a-c. A Profiles table 2419a may include fields such as, but not limited to: user ID, user name, contact info, user group affiliation, demographic information, offer preferences, selected causes and/or charities, donation distributions, offer and/or transaction histories, payment methods, and/or the like. An Offers table 2419b may include fields such as, but not limited to: offer ID, offer name, offer originator(s), offer participant(s), description, terms, conditions, restrictions, start date, end date, qualified products, price adjustments, associated advertisement(s), and/or the like. A Transactions table 2419c may include fields such as, but not limited to: transaction ID, date/time, location, product(s), payment amount, payment method, customer ID, associated offers, associated ads, brands, and/or the like. These and/or other tables may support and/or track multiple entity accounts on the Platform.

In one embodiment, the Platform database may interact with other database systems. For example, employing a distributed database system, queries and data access by Platform modules may treat the combination of the Platform database and another database as a single database entity.

In one embodiment, user programs may contain various user interface primitives, which may serve to update the Platform. Also, various accounts may require custom database tables depending upon the environments and the types of clients the Platform may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2419a-c. The Platform may be configured to keep track of various settings, inputs, and parameters via database controllers.

The Platform database may communicate to and/or with other components in a component collection, including itself, and/or facilities of the like. Most frequently, the Platform database communicates with the Platform component, other program components, and/or the like. The database may contain, retain, and provide information regarding other nodes and data.

The Platform Component

The Platform component 2435 is a stored program component that is executed by a CPU. The Platform component affects accessing, obtaining and the provision of information, services, transactions, and/or the like across various communications networks. As such, the Platform component enables one to access, calculate, engage, exchange, generate, identify, instruct, match, process, search, serve, store, and/or facilitate transactions and interactions within a donation-coordinating electronic market. In one embodiment, the Platform component incorporates any and/or all combinations of the aspects of the Platform that were discussed in the previous figures and appendices.

The Platform component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the Platform server employs a cryptographic server to encrypt and decrypt communications. The Platform component may communicate to and/or with other components in a component collection, including itself and/or facilities of the like. Most frequently, the Platform component communicates with the Platform database, operating systems, other program components, and/or the like. The Platform may contain, communicate, generate, obtain, and/or provide program component, system, user, and/or data communications, requests, and/or responses.

Distributed Platform

The structure and/or operation of any of the Platform node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Platform controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

1-33. (canceled)

34. A processor-implemented method for coordinating donations, comprising:
receiving a brand donation commitment contingent on a triggering consumer purchase from at least one brand;
receiving a co-donation commitment contingent on the triggering consumer purchase from at least one consumer associate;
receiving a consumer purchase confirmation message, wherein the consumer purchase confirmation message confirms that the triggering consumer purchase has taken place;
generating an account of brand fund transfer from the brand to at least one consumer-selected cause based on the brand donation commitment; and
generating an account of consumer associate fund transfer from the consumer associate to at least one consumer-selected cause based on the co-donation commitment.

35. The method of claim 34, wherein the at least one brand is a retail brand.

36. The method of claim 35, further comprising:
receiving a manufacturer brand commitment contingent on a triggering consumer purchase from at least one manufacturing brand; and
generating an account of manufacturer brand fund transfer from the manufacturer brand to at least one consumer-selected cause based on the manufacturer brand donation commitment.

37. The method of claim 36, further comprising:
receiving a payment brand commitment contingent on a triggering consumer purchase from at least one payment brand; and
generating an account of payment brand fund transfer from the payment brand to at least one consumer-selected cause based on the payment brand donation commitment.

38. The method of claim 35, further comprising:
receiving a payment brand commitment contingent on a triggering consumer purchase from at least one payment brand; and
generating an account of payment brand fund transfer from the payment brand to at least one consumer-selected cause based on the payment brand donation commitment.

39. The method of claim 38, wherein the payment brand comprises a credit card company.

40. The method of claim 34, further comprising:
prior to receiving a consumer purchase confirmation message:
providing a donation notice of the brand donation commitment to a consumer; and
receiving a purchase commitment from the consumer in response to the donation notice, the purchase commitment comprising an agreement to make the triggering consumer purchase.

41. The method of claim 40, wherein the donation notice is provided to the consumer by email.

42. The method of claim 40, wherein the donation notice is provided to the consumer on a website.

43. The method of claim 40, wherein the donation notice is provided to the consumer in response to a consumer search query.

44. The method of claim 40, wherein the donation notice is provided to the consumer in a print ad.

45. The method of claim 40, wherein the donation notice of the brand donation commitment is provided to a consumer who has previously expressed an interest in the corresponding brand.

46. The method of claim 34, wherein the brand donation commitment comprises a percentage of the triggering consumer purchase price.

47. The method of claim 46, wherein the brand donation commitment further comprises a total donation limit amount.

48. The method of claim 34, wherein the brand donation commitment includes a donation time frame.

49. The method of claim 48, wherein the donation time frame includes a start time and an end time.

50. The method of claim 34, wherein the at least one consumer associate is a consumer employer.

51-257. (canceled)

258. An apparatus to coordinate donations, comprising:
a memory;
a processor disposed in communication with said memory, and configured to issue a plurality of instructions stored in the memory, wherein the instructions issue signals to:
receive a brand donation commitment contingent on a triggering consumer purchase from at least one brand;
receive a co-donation commitment contingent on the triggering consumer purchase from at least one consumer associate;
receive a consumer purchase confirmation message, wherein the consumer purchase confirmation message confirms that the triggering consumer purchase has taken place;
generate an account of brand fund transfer from the brand to at least one consumer-selected cause based on the brand donation commitment; and
generate an account of consumer associate fund transfer from the consumer associate to at least one consumer-selected cause based on the co-donation commitment.

259-369. (canceled)

370. A medium readable by a processor to coordinate donations, comprising:
instruction signals in the processor readable medium, wherein the instruction signals are issuable by the processor to:
receive a brand donation commitment contingent on a triggering consumer purchase from at least one brand;
receive a co-donation commitment contingent on the triggering consumer purchase from at least one consumer associate;
receive a consumer purchase confirmation message, wherein the consumer purchase confirmation message confirms that the triggering consumer purchase has taken place;
generate an account of brand fund transfer from the brand to at least one consumer-selected cause based on the brand donation commitment; and
generate an account of consumer associate fund transfer from the consumer associate to at least one consumer-selected cause based on the co-donation commitment.

371-448. (canceled)
